(19) United States
(12) Patent Application Publication
(10) Pub. No.: US 2025/0186983 A1
(43) Pub. Date: Jun. 12, 2025

(54) GENERAL METHOD FOR GROWING TRANSITION METAL CATALYST NANOPARTICLES WITH SIZES OF SINGLE-DIGIT NANOMETERS ON DIELECTRIC OXIDES

(71) Applicant: Temple University-Of The Commonwealth System of Higher Education, Philadelphia, PA (US)

(72) Inventors: YUGANG SUN, Gladwyne, PA (US); QILIN WEI, Beijing (CN)

(21) Appl. No.: 18/971,459

(22) Filed: Dec. 6, 2024

Related U.S. Application Data
(60) Provisional application No. 63/607,247, filed on Dec. 7, 2023.

(51) Int. Cl. B01J 37/02; B01J 21/02; B01J 21/08; B01J 23/02; B01J 23/06; B01J 23/34; B01J 23/42; B01J 23/44; B01J 23/46; B01J 23/52; B01J 23/72; B01J 23/745; B01J 23/75; B01J 23/755; B01J 35/39; B01J 35/45; B01J 35/51; B01J 37/08; B01J 37/18

(52) U.S. Cl. CPC B01J 37/0228; B01J 21/02; B01J 21/08; B01J 23/02; B01J 23/06; B01J 23/34; B01J 23/42; B01J 23/44; B01J 23/462; B01J 23/464; B01J 23/52; B01J 23/72; B01J 23/745; B01J 23/75; B01J 23/755; B01J 35/39; B01J 35/45; B01J 35/51; B01J 37/0221; B01J 37/0236; B01J 37/0244; B01J 37/08; B01J 37/18

(57) ABSTRACT

In one aspect, the present invention relates to a method of fabricating a nanoparticle material, the method comprising: providing silica nanospheres; dispersing the silica nanospheres in a first solvent; collecting and drying the silica nanospheres; dispersing the silica nanospheres in a second solvent and adding a metal precursor to create composite nanoparticles; and collecting and drying the composite nanoparticles to create a nanoparticle material.

In another aspect, the present invention relates to nanoparticle material comprising silica nanospheres, wherein the silica nanospheres are coated with metal nanoparticles with diameters less than 40 nm.

### CROSS REFERENCE TO RELATED APPLICATIONS

The present application claims priority to U.S. Provisional Application No. 63/607,247, filed Dec. 7, 2023, which is incorporated by reference herein in its entirety.

### BACKGROUND OF THE INVENTION

In the modern study of light-matter interaction, a substantial number of efforts have been devoted to research on condensed matter. Generally, materials are categorized into conductors, semiconductors, and insulators, depending on the energy gap between the valence band and the conduction band. These materials behave differently under the illumination of light. With the assistance of thermal energy at a certain temperature, the electrons in conductors can be excited to higher energy levels, the electrons in semiconductors can be excited only when the light energy is higher than their band gap, while those in insulators cannot be exited. The excited electrons carrying the energy from the photons can deliver these energies to other matters to drive physical or chemical processes. Since the past few decades, studies of light-matter interactions have been of great interests, and academic products have benefited electronics, medical sciences, and chemical industries (Harrison, W. A. Electronic Structure and the Properties of Solids: the Physics of the Chemical Bond. Courier Corp., 2012; Cortie, M. B. et al., Chem. Rev. 2011, 111, 3713-3735; Dini, D. et al., Chem. Rev. 2016, 116, 13043-13233; Gonzilez-Urbina, L. et al., Chem. Rev. 2012, 112, 2268-2285; Hsu, S.-W. et al., Chem. Rev. 2018, 118, 3100-3120; Tadepalli, S. et al., Chem. Rev. 2017, 117, 12705-12763).

Nanoparticles present plenty of unique properties in thermodynamics, surface structures, optical responses, and so on. Their large surface energies and unique optical absorption properties are especially crucial to applications of metal and metal oxyhydroxide nanoparticles. As the size of the particle decreases, its mass-specific surface area increases tremendously. This higher surface area allows more active sites to interact with other substrates for the following physical or chemical processes. The high surface energy is also originated from their non-perfect surface structures. The high curvature of small nanoparticles creates plenty of surface defects and high-index facets. These highly unsaturated sites have a higher potential to adsorb other chemical species and may lower the activation energy of chemical reactions (Sergeev, G. B., 7—Size Effects in Nanochemistry. Ed. Elsevier Science: Amsterdam, 2006)

Nanoparticles also present some attractive optical properties. One of the well-known phenomena in some small noble metal nanoparticles is the localized surface plasmon resonances (LSPR). LSPRs result in strong absorption of a certain frequency of light in ultraviolet-to-visible light (UV-vis) region in silver (Ag), gold (Au), copper (Cu), and aluminum (Al) nanoparticles. This excitation can generate a great number of high-energy electrons at the excitation frequency, and these electrons can be injected into other adsorbed substrates to drive chemical processes. The utilization of ubiquitous solar energy and converting it into other forms of energy with high efficiency is highly favorable in accordance with the goal of overcoming the energy crisis and low-carbon production strategies (M. H. Nayfeh. “Optics in nanotechnology,” in Optics in Our Time. Springer, 2016).

Even though the synthesis of free-standing nanoparticles has been well-developed, the nanoparticles dispersed in liquid media are usually hard to purify and suffer from aggregation. Loading metal or metal oxyhydroxide nanoparticles onto support materials can not only increase their stability but also benefit the application through interaction between the nanoparticle and the support materials chemically or optically.

Thus, there is need in the art for ultrafine metal nanoparticles and methods of making such nanoparticles. The present invention satisfies this unmet need.

### SUMMARY OF THE INVENTION

In one aspect, the present invention relates to a method of fabricating a nanoparticle material, the method comprising: providing silica nanospheres; dispersing the silica nanospheres in a first solvent; collecting and drying the silica nanospheres; dispersing the silica nanospheres in a second solvent and adding a metal precursor to create composite nanoparticles; collecting and drying the composite nanoparticles to create a nanoparticle material. In some embodiments, the silica nanospheres have diameters less than 1500 nm. In some embodiments, the step of dispersing the silica nanospheres in a first solvent further comprises the step of altering the pH of the first solvent to reach a value between 8 and 13. In some embodiments, the step of altering the pH of the first solvent comprises the step of adding a base or an acid to the first solvent. In some embodiments, the step of dispersing the silica nanospheres in a second solvent further comprises the step of altering the pH of the second solvent to reach a value between 5 and 14. In some embodiments, the step of altering the pH of the second solvent to reach a value between 5 and 14 comprises the step of adding an acid or a base to the second solvent.

In some embodiments, the metal precursor is selected from the group consisting of: manganese(II) nitrate hydrate (Mn(NO₃)₂·xH₂O), Iron(II) chloride (FeCl₂), cobalt(II) nitrate hexahydrate (Co(NO₃)₂·6H₂O), nickel(II) nitrate hexahydrate (Ni(NO₃)₂·6H₂O), copper(II) nitrate trihydrate (Cu(NO₃)₂·3H₂O), ruthenium(III) chloride hydrate (RuCl₃·xH₂O), sodium tetrachloropalladate(II) hydrate (Na₂PdCl₄·xH₂O), sodium hexachlororhodate(III) hydrate (Na₃RhCl₆·xH₂O), tetrachloroauric(III) acid trihydrate (HAuCl₄·3H₂O), sodium tetrachloroplatinate(II) hydrate (Na₂PtCl₄·xH₂O), potassium tetrachloroplatinate(II) hydrate (K₂PtCl₄·xH₂O), sodium hexachloroplatinate (Na₄PtCl₆), potassium hexachloroplatinate (K₄PtCl₆), magnesium chloride (MgCl₂), aluminum nitrate nonahydrate (Al(NO₃)₂·9H₂O), zinc nitrate hexahydrate (Zn(NO₃)₂·6H₂O), and combinations thereof. In some embodiments, the step of adding a metal precursor comprises the step of adding an aqueous metal precursor solution with less than 50.0 wt % of a metal precursor.

In some embodiments, the composite nanoparticles comprise metal nanoparticles with diameters less than 40 nm. In some embodiments, the step of collecting and drying the composite nanoparticles further comprises the step of reducing the composite nanoparticles. In some embodiments, the step of reducing the composite nanoparticles comprises the step of thermally reducing the composite nanoparticles. In some embodiments, the step of thermally reducing the composite nanoparticles comprises the step of contacting the composite nanoparticles with a flow of 5% H₂/N₂ gas. In some embodiments, the step of reducing the composite nanoparticles further comprises the step of coating the composite nanoparticles with a dielectric material coating. In some embodiments, the step dispersing the silica nanospheres in a second solvent, altering the pH of the second solvent, and adding a metal precursor the composite nanoparticles, comprises the step of anchoring the metal precursors to the surface of the silica nanospheres through metal-silane bonds.

In one aspect, the present invention relates to a nanoparticle material comprising silica nanospheres, wherein the silica nanospheres are coated with metal nanoparticles with diameters less than 40 nm. In some embodiments, the silica nanospheres comprise a dielectric material. In some embodiments, the dielectric material comprises a compound selected from the group consisting of silicon oxide (SiO₂), aluminum oxide (Al₂O₃), tantalum pentoxide (Ta₂O₅), titanium oxide (TiO₂), tungsten Oxide (WO₃), zirconium oxide (ZrO₂), yttrium oxide (Y₂O₃), silicon nitride (SiN₄), cerium oxide (CeO₂), iron oxide (Fe₂O₃), lanthanum oxide (La₂O₃), hafnium oxide (HfO₂), chromium oxide (Cr₂O₃), strontium titanate (STO), barium strontium titanate (BST), PLZT (lead zirconate titanate), lead magnesium niobate (PMN), and lead zirconate titanate (PZT), and combinations thereof. In some embodiments, the silica nanospheres have diameters less than 1500 nm. In some embodiments, the metal nanoparticles comprises a metal selected from the group consisting of: gold (Au), silver (Ag), copper (Cu), aluminum (Al), magnesium (Mg), iron (Fe), cobalt (Co), nickel (Ni), ruthenium (Ru), palladium (Pd), rhodium (Rh), platinum (Pt), manganese (Mn), zinc (Zn), molybdenum (Mo), tin (Sn), antimony (Sb), tungsten (W), rhenium (Re), iridium (Ir), and their combinations thereof. In some embodiments, the metal nanoparticles are anchored to the surface of the nanospheres through metal-silane bonds.

### BRIEF DESCRIPTION OF THE DRAWINGS

The following detailed description of various embodiments of the invention will be better understood when read in conjunction with the appended drawings. For the purpose of illustrating the invention, there are shown in the drawings illustrative embodiments. It should be understood, however, that the invention is not limited to the precise arrangements and instrumentalities of the embodiments shown in the drawings.

FIG. 1 depicts a schematic illustration of the two sequential steps involved in synthesizing ultrafine metal nanoparticles (ufMNPs) on silica nanospeheres (SiOₓ NSs).

FIG. 2, comprising FIGS. 2A through 2C, depicts a schematic illustration of the “surface acid-base reaction” strategy responsible for loading metal cations to SiOₓ NS's surface. FIG. 2A depicts SiOₓ NSs with a dehydrated surface (i.e., —Si—O—Si— termination group) or partially hydrated surface are incubated in hot (or warm) water to generate a highly hydrated surface that is terminated with a high density of —Si—OH groups. FIG. 2B depicts the surface acid-base reaction between metal cations (M^{m+}) and —Si—O⁻ loading the metal cations onto the SiOₓ NSs. FIG. 2C depicts the alternating switch of surface property between the Lewis base and Lewis acid driving the continuous loading of M^{m+} cations and hydroxide (OH⁻) anions to the surface of the SiOₓ NSs.

FIG. 3, comprising FIG. 3A through FIG. 3D, depicts scanning electron microscopy (SEM) and transmission electron microscopy (TEM) images of synthesized SiOₓ NSs. FIG. 3A depicts a SEM image of an as-synthesized SiOₓ NSs. FIG. 3B depicts a TEM image of an as-synthesized SiOₓ NSs. FIG. 3C depicts a SEM image of a treated an as-synthesized SiOₓ NSs with rich surface —Si—O— groups. FIG. 3D depicts a TEM image of a treated an as-synthesized SiOₓ NSs with rich surface —Si—O⁻ groups. The TEM images of the single particles in FIG. 3B and FIG. 3D show their high geometric symmetry (sphere), highlighting subtle surface roughness after the etching treatment

FIG. 4 depicts a graph plotting the Zeta potential of the treated SiOₓ NSs suspended in aqueous solution as a function of the pH value of the solution.

FIG. 5, comprising FIG. 5A through FIG. 5J, depicts TEM images of different metal oxyhydroxide silica (MO_{y}(OH)_{z}/SiOₓ) composite particles highlighting the deposited MO_{y}(OH)_{z} coating with evenly spatial distribution on the SiOₓ NSs. Scale bars represent 20 nm. FIG. 5A depicts MnO_{y}(OH)_{z}/SiOₓ nanoparticles. FIG. 5B depicts FeO_{y}(OH)_{z}/SiOₓ nanoparticles. FIG. 5C depicts CoO_{y}(OH)_{z}/SiOₓ nanoparticles. FIG. 5D depicts NiO_{y}(OH)_{z}/SiOₓ nanoparticles. FIG. 5E depicts CuO_{y}(OH)_{z}/SiOₓ nanoparticles. FIG. 5F depicts RuO_{y}(OH)_{z}/SiOₓ nanoparticles. FIG. 5G depicts RhO_{y}(OH)_{z}/SiOₓ nanoparticles. FIG. 5H depicts PdO_{y}(OH)_{z}/SiOₓ nanoparticles. FIG. 5I depicts PtO_{y}(OH)_{z}/SiOₓ nanoparticles. FIG. 5J depicts AuO_{y}(OH)_{z}/SiOₓ nanoparticles.

FIG. 6, comprising FIG. 6A through FIG. 6K, depicts TEM images of individual composite particles containing a thin coating of MO_{y}(OH)_{z} evenly distributed on the SiOₓ NSs. FIG. 6A depicts MnO_{y}(OH)_{z}/SiOₓ nanoparticles. FIG. 6B depicts FeO_{y}(OH)_{z}/SiOₓ nanoparticles. FIG. 6C depicts CoO_{y}(OH)_{z}/SiOₓ nanoparticles. FIG. 6D depicts NiO_{y}(OH)_{z}/SiOₓ nanoparticles. FIG. 6E depicts CuO_{y}(OH)_{z}/SiOₓ nanoparticles. FIG. 6F depicts RuO_{y}(OH)_{z}/SiOₓ nanoparticles. FIG. 6G depicts RhO_{y}(OH)_{z}/SiOₓ nanoparticles. FIG. 6H depicts PdO_{y}(OH)_{z}/SiOₓ nanoparticles. FIG. 6I depicts PtO_{y}(OH)_{z}/SiOₓ nanoparticles. FIG. 6J depicts AuO_{y}(OH)_{z}/SiOₓ nanoparticles. FIG. 6K depicts a blown-up image of RuO_{y}(OH)_{z}/SiOₓ nanoparticle highlighting the even distribution of individual RuO_{y}(OH)_{z} nanoparticles on silica surface. The scale bars in FIG. 6A through FIG. 6I represent 50 nm.

FIG. 7, comprising FIG. 7A through FIG. 7H, depicts TEM images of individual composite particles containing a thin coating of MO_{y}(OH)_{z} uniformly on the SiOₓ NSs. FIG. 7A and FIG. 7E depicts AlO_{y}(OH)_{z}/SiOₓ nanoparticles. FIG. 7B and FIG. 7F depicts MgO_{y}(OH)_{z}/SiOₓ nanoparticles. FIG. 7C and FIG. 7G depicts ZnO_{y}(OH)_{z}/SiOₓ nanoparticles. FIG. 7D and FIG. 7H depicts MnO_{y}(OH)_{z}/SiOₓ nanoparticles. The scale bars in FIG. 7A through FIG. 7D represent 50 nm and the scale bars through FIG. 7E through FIG. 7H represent 20 nm. The ultrafine MnO₂ NPs on the SiOₓ NSs were obtained by treating the MnO_{y}(OH)_{z}/SiOₓ composite particles shown in FIG. 5A with H₂O₂.

FIG. 8, comprising FIG. 8A through FIG. 8J, depicts TEM images of ufMNPs/SiOₓ composite particles highlighting the ultrasmall sizes and good dispersity of the metal nanoparticles on the SiOₓ NSs. Since the ufMNPs containing Mn, Fe, and Co are easily oxidized upon exposure to air, they are intentionally labeled as MnO_{y}, FeO_{y}, and CoO_{y} in the imaged samples to reflect their chemical instability in air. Scale bars represent 20 nm. FIG. 8A depicts MnO_{y}(OH)_{z}/SiOₓ nanoparticles. FIG. 8B depicts FeO_{y}(OH)_{z}/SiOₓ nanoparticles. FIG. 8C depicts CoO_{y}(OH)_{z}/SiOₓ nanoparticles. FIG. 8D depicts NiO_{y}(OH)_{z}/SiOₓ nanoparticles. FIG. 8E depicts Cu₂Oy(OH)_{z}/SiOₓ nanoparticles. FIG. 8F depicts RuO_{y}(OH)_{z}/SiOₓ nanoparticles. FIG. 8G depicts RhO_{y}(OH)_{z}/SiOₓ nanoparticles. FIG. 8H depicts PdO_{y}(OH)_{z}/SiOₓ nanoparticles. FIG. 8I depicts PtO_{y}(OH)_{z}/SiOₓ nanoparticles. FIG. 8J depicts AuO_{y}(OH)_{z}/SiOₓ nanoparticles.

FIG. 9, comprising FIG. 9A through FIG. 9J, depicts TEM images of the composite particles containing ufMNPs of different elements. Scale bars represent 50 nm. FIG. 9A depicts MnO_{y}(OH)_{z}/SiOₓ nanoparticles. FIG. 9B depicts FeO_{y}(OH)_{z}/SiOₓ nanoparticles.

FIG. 9C depicts CoO_{y}(OH)_{z}/SiOₓ nanoparticles. FIG. 9D depicts NiO_{y}(OH)_{z}/SiOₓ nanoparticles. FIG. 9E depicts Cu₂Oy(OH)_{z}/SiOₓ nanoparticles. FIG. 9F depicts RuO_{y}(OH)_{z}/SiOₓ nanoparticles. FIG. 9G depicts RhO_{y}(OH)_{z}/SiOₓ nanoparticles. FIG. 9H depicts PdO_{y}(OH)_{z}/SiOₓ nanoparticles. FIG. 9I depicts PtO_{y}(OH)_{z}/SiOₓ nanoparticles. FIG. 9J depicts AuO_{y}(OH)_{z}/SiOₓ nanoparticles.

FIG. 10, comprising FIGS. 10A through FIG. 10D, depicts TEM images of Ni ufMNPs on SiOₓ NSs. FIG. 10A and FIG. 10B depict TEM images of Ni ufMNPs on SiOₓ NSs derived from reducing NiO_{y}(OH)_{z}/SiOₓ composite particles at 750° C. FIG. 10C depicts a TEM image of Ni-ufMNPs/SiOₓ composite particles derived from the reduction of NiO_{y}(OH)_{z}/SiOₓ composite particles at 550° C. followed by coating a thin silica layer. FIG. 10D depicts a TEM image of the composite particles of FIG. 10C annealed at 750° C. in forming gas (i.e., 5% H₂/95% N₂). The scale bars in FIGS. 10A, FIG. 10C, and FIG. 10D are 50 nm, and the scale bar in FIG. 10B is 20 nm.

FIG. 11 depicts synchrotron wide-angle X-ray (WAXS) scattering patterns of the ultrafine nanoparticles formed on the SiOₓ NSs through loading metal ions in the MO_{y}(OH)_{z} form and thermal reduction of MO_{y}(OH)_{z} in forming gas. The patterns were derived by subtracting the WAXS signal of the SiOₓ NSs from the composite samples.

FIG. 12 depicts WAXS patterns of composite particles of various thin coatings on SiOₓ NSs. The WAXS signals of the thin coatings were calculated by subtracting the WAXS pattern of the SiOₓ NSs (top curve).

FIG. 13, comprising FIG. 13A through FIG. 13K, depicts diffuse reflectance spectroscopy (DRS) spectra of particle powders made of different compositions. FIG. 13A depicts DRS spectra of the as-synthesized SiOₓ NSs (dashed curve) and the treated SiOₓ NSs with the rich surface —Si—O⁻ groups (solid curve). FIG. 13B, FIG. 13C, FIG. 13D, FIG. 13E, FIG. 13F, FIG. 13G, FIG. 13H, FIG. 13I, FIG. 13J, and FIG. 13K depict DRS spectra of the MO_{y}(OH)_{z}/SiOₓ composite particles (dashed curves) and the composite particles containing ultrafine nanoparticles after thermal reduction (solid curves). FIG. 13L depicts DRS spectra of the composite samples containing ultrafine nanoparticles of AlO_{y}(OH)_{z}, MgO_{y}(OH)_{z}, ZnO_{y}(OH)_{z}, and MnO₂.

FIG. 14, comprising FIG. 14A through FIG. 14F, depicts TEM images of the SiOₓ NSs loaded with CuNiO_{y}(OH)_{z}. The insets are blown up images. FIG. 14A depicts a TEM image of the SiOₓ NSs loaded with CuNiO_{y}(OH)_{z} with a ratio between Cu(II) and Ni(II) in the synthesis solution of 1:4. FIG. 14B depicts a TEM image of the SiOₓ NSs loaded with CuNiO_{y}(OH)_{z} with a ratio between Cu(II) and Ni(II) in the synthesis solution of 1:2.5. FIG. 14C depicts a TEM image of the SiOₓ NSs loaded with CuNiO_{y}(OH)_{z} with a ratio between Cu(II) and Ni(II) in the synthesis solution of 1:1. FIG. 14D depicts a TEM image of the CuNi ufMNPs from FIG. 14A after thermal reduction in forming gas at 550° C. FIG. 14E depicts a TEM image of the CuNi ufMNPs from FIG. 14B after thermal reduction in forming gas at 550° C. FIG. 14F depicts a TEM image of the CuNi ufMNPs from FIG. 14C after thermal reduction in forming gas at 550° C. The scale bar in FIG. 14A is 50 nm and that in the inset is 20 nm, which also apply to FIGS. 14B through FIG. 14F. Regardless of the Cu/Ni ratios, the deposited CuNiO_{y}(OH)_{z} exhibits a thin film morphology that uniformly wraps the SiOₓ NSs. The uniform films are transformed to CuNi ufMNPs that are evenly distributed on the SiOₓ NSs.

FIG. 15, comprising FIG. 15A through FIG. 15D, depicts TEM images of the SiOₓ NSs loaded with RuPdO_{y}(OH)_{z}. FIG. 15A and FIG. 15B depict TEM images of the SiOₓ NSs loaded with RuPdO_{y}(OH)_{z} with Ru/Pd=1. FIG. 15C and FIG. 15D depict TEM images of the SiOₓ NSs loaded with RuPdO_{y}(OH)_{z} with Ru/Pd=1 after thermal reduction in forming gas at 250° C. The loaded RuPdO_{y}(OH)_{z} exhibits the morphology of ultrafine nanoparticles, similar to the RuPd ufMNPs after thermal reduction in the forming gas at 250° C. The scale bars in FIG. 15A, FIG. 15C, and FIG. 15D are 50 nm, and the scale bar in FIG. 15B is 20 nm.

FIG. 16, comprising FIG. 16A through 16D, depicts DRS spectra of the composite particles containing bimetallic MO_{y}(OH)_{z} and bimetallic ufMNPs as shown in FIG. 14 and FIG. 15. FIGS. 16A, FIG. 16B, and FIG. 16C depict CuNi samples with different Cu/Ni ratios. FIG. 16D depicts RuPd samples with Ru/Pd=1.

FIG. 17 depicts a design for flow synthesis with scaling potential.

FIG. 18 depicts method 100.

### DETAILED DESCRIPTION

The invention is in part based on silica nanospheres coated with metal nanoparticles which exhibit strong optical absorption in the visible spectral range. A general synthesis is reported wherein the metal nanoparticles are uniformly distributed among the surface of the silica nanospheres.

It is to be understood that the Figures and descriptions of the present invention have been simplified to illustrate elements that are relevant for a clear understanding of the present invention, while eliminating, for the purpose of clarity, many other elements found in polymer composites and methods of making. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

As used herein, each of the following terms has the meaning associated with it in this section. Unless defined otherwise, all technical and scientific terms used herein generally have the same meaning as commonly understood by one of ordinary skill in the art to which this invention belongs.

The articles “a” and “an” are used herein to refer to one or to more than one (i.e. to at least one) of the grammatical object of the article. By way of example, “an element” means one element or more than one element.

As used herein, the term “about” will be understood by persons of ordinary skill in the art and will vary to some extent depending on the context in which it is used. As used herein when referring to a measurable value such as an amount, a temporal duration, and the like, the term “about” is meant to encompass variations of 20% or +10%, more preferably +5%, even more preferably ±1%, and still more preferably ±0.1% from the specified value, as such variations are appropriate to perform the disclosed methods.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

### Nanoparticle Materials

In one aspect, the present invention relates to a nanoparticle material comprising nanospheres, wherein the nanospheres are coated with metal nanoparticles.

In some embodiments, the nanospheres are silica nanospheres. In some embodiments, the nanospheres comprises a dielectric material. In some embodiments, the silica nanospheres comprises a dielectric material. In some embodiments, the nanospheres comprise a metal oxide. In some embodiments, the dielectric material comprises inorganic elements such as silicon, zirconium, calcium, tungsten, cerium, iron, chromium, strontium, lead, magnesium, tin, titanium, yttrium, lanthanum, aluminum, hafnium, barium, tantalum, and the like. In some embodiments, the dielectric material comprises a metal oxide. In some embodiments, the dielectric material comprises a compound including, but not limited to, silicon oxide (SiO₂), aluminum oxide (Al₂O₃), tantalum pentoxide (Ta₂O₅), titanium oxide (TiO₂), calcium oxide (CaO), tungsten Oxide (WO₃), zirconium oxide (ZrO₂), yttrium oxide (Y₂O₃), silicon nitride (SiN₄), cerium oxide (CeO₂), iron oxide (Fe₂O₃), lanthanum oxide (La₂O₃), hafnium oxide (HfO₂), chromium oxide (Cr₂O₃), strontium titanate (STO), barium strontium titanate (BST), PLZT (lead zirconate titanate), lead magnesium niobate (PMN), lead zirconate titanate (PZT), other metal oxides, and combinations thereof. In some embodiments, the nanospheres are silane-functionalized.

In some embodiments the nanospheres comprise polymers such as thermoplastic elastomers, olefinic materials, polyolefin, polyurethane thermoplastic elastomers, polyamides, polyimides, synthetic rubbers, polytetrafluoroethylene (PTFE), polydimethylsiloxane (PDMS), polybutadiene, polyisobutylene, polystyrenes, polyurethanes, polychloroprene and silicones. Other dielectric materials include, but are not limited to: ceramics, glass, reinforced laminates such as polytetrafluoroethylene (PTFE) reinforced with glass, mica minerals and crystals, and non-conductive oxides.

In some embodiments, the nanospheres have diameters greater than 1 nm. In some embodiments, the nanospheres have diameters greater than 10 nm. In some embodiments, the nanospheres have diameters greater than 25 nm. In some embodiments, the nanospheres have a diameter greater than 50 nm. In some embodiments, the nanospheres have diameters greater than 100 nm. In some embodiments, the nanospheres have diameters greater than 200 nm. In some embodiments, the nanospheres have diameters greater than 300 nm. In some embodiments, the nanospheres have diameters greater than 400 nm. In some embodiments, the nanospheres have diameters greater than 500 nm. In some embodiments, the nanospheres have diameters greater than 750 nm. In some embodiments, the nanospheres have diameters greater than 1000 nm. In some embodiments, the nanospheres have diameters greater than 1200 nm. In some embodiments, the nanospheres have diameters greater than 1500 nm. In some embodiments, the nanospheres have diameters greater than 2000 nm.

In some embodiments, the nanospheres have diameters less than 5 nm. In some embodiments, the nanospheres have diameters less than 10 nm. In some embodiments, the nanospheres have diameters less than 25 nm. In some embodiments, the nanospheres have diameters less than 50 nm. In some embodiments, the nanospheres have diameters less than 100 nm. In some embodiments, the nanospheres have diameters less than 200 nm. In some embodiments, the nanospheres have diameters less than 300 nm. In some embodiments, the nanospheres have diameters less than 400 nm. In some embodiments, the nanospheres have diameters less than 500 nm. In some embodiments, the nanospheres have diameters less than 750 nm. In some embodiments, the nanospheres have diameters less than 1000 nm. In some embodiments, the nanospheres have diameters less than 1200 nm. In some embodiments, the nanospheres have diameters less than 1500 nm. In some embodiments, the nanospheres have diameters less than 2000 nm.

In some embodiments, the metal nanoparticles comprise a metal. Exemplary metals include, but not limited to, gold (Au), silver (Ag), copper (Cu), aluminum (Al), magnesium (Mg), iron (Fe), cobalt (Co), nickel (Ni), ruthenium (Ru), molybdenum (Mo), tin (Sn), antimony (Sb), tungsten (W), rhenium (Re), iridium (Ir), palladium (Pd), rhodium (Rh), platinum (Pt), manganese (Mn), zinc (Zn), and their combinations thereof.

In some embodiments, the nanospheres are silica nanospheres. In some embodiments, the metal nanoparticles are anchored to the silica nanospheres through metal-silane bonds. In some embodiments, the metal nanoparticles are uniformly distributed on the nanospheres. In some embodiments, the metal nanoparticles are randomly distributed on the nanospheres. In some embodiments, the metal nanoparticles coat the nanospheres through a film-like coating. In some embodiments, the nanospheres coated with metal nanoparticles further comprise a dielectric material coating over the metal nanoparticles. In some embodiments, the dielectric material coating comprises a dielectric material such as those described above. In some embodiments, the dielectric material coating is a layer of silica. In some embodiments, there is a dielectric material coating between the nanospheres and the metal nanoparticles. In some embodiments, the dielectric material coatings described herein are less than 100 nm thick. In some embodiments, the dielectric material coatings described herein are less than 90 nm thick. In some embodiments, the dielectric material coatings described herein are less than 80 nm thick. In some embodiments, the dielectric material coatings described herein are less than 70 nm thick. In some embodiments, the dielectric material coatings described herein are less than 60 nm thick. In some embodiments, the dielectric material coatings described herein are less than 50 nm thick. In some embodiments, the dielectric material coatings described herein are less than 40 nm thick. In some embodiments, the dielectric material coatings described herein are less than 30 nm thick. In some embodiments, the dielectric material coatings described herein are less than 20 nm thick. In some embodiments, the dielectric material coatings described herein are less than 10 nm thick. In some embodiments, the dielectric material coatings described herein are less than 9 nm thick. In some embodiments, the dielectric material coatings described herein are less than 8 nm thick. In some embodiments, the dielectric material coatings described herein are less than 7 nm thick. In some embodiments, the dielectric material coatings described herein are less than 6 nm thick. In some embodiments, the dielectric material coatings described herein are less than 5 nm thick. In some embodiments, the dielectric material coatings described herein are less than 4 nm thick. In some embodiments, the dielectric material coatings described herein are less than 3 nm thick. In some embodiments, the dielectric material coatings described herein are less than 2 nm thick. In some embodiments, the metal nanoparticles comprise metal oxyhydroxides MO_{y}(OH)_{Z}. In some embodiments, the metal nanoparticles comprise metal oxides (MO_{y}).

In some embodiments, the metal nanoparticles have diameters less than 200 nm. In some embodiments, the metal nanoparticles have diameters less than 100 nm. In some embodiments, the metal nanoparticles have diameters less than 90 nm. In some embodiments, the metal nanoparticles have diameters less than 80 nm. In some embodiments, the metal nanoparticles have diameters less than 70 nm. In some embodiments, the metal nanoparticles have diameters less than 60 nm. In some embodiments, the metal nanoparticles have diameters less than 50 nm. In some embodiments, the metal nanoparticles have diameters less than 40 nm. In some embodiments, the metal nanoparticles have diameters less than 30 nm. In some embodiments, the metal nanoparticles have diameters less than 20 nm. In some embodiments, the metal nanoparticles have diameters less than 10 nm. In some embodiments, the metal nanoparticles have diameters less than 9 nm. In some embodiments, the metal nanoparticles have diameters less than 8 nm. In some embodiments, the metal nanoparticles have diameters less than 7 nm. In some embodiments, the metal nanoparticles have diameters less than 6 nm. In some embodiments, the metal nanoparticles have diameters less than 5 nm. In some embodiments, the metal nanoparticles have diameters less than 4 nm. In some embodiments, the metal nanoparticles have diameters less than 3 nm. In some embodiments, the metal nanoparticles have diameters less than 2 nm. In some embodiments, the metal nanoparticles have diameters less than 1 nm.

In some embodiments, the metal nanoparticles have diameters greater than 200 nm. In some embodiments, the metal nanoparticles have diameters greater than 100 nm. In some embodiments, the metal nanoparticles have diameters greater than 90 nm. In some embodiments, the metal nanoparticles have diameters greater than 80 nm. In some embodiments, the metal nanoparticles have diameters greater than 70 nm. In some embodiments, the metal nanoparticles have diameters greater than 60 nm. In some embodiments, the metal nanoparticles have diameters greater than 50 nm. In some embodiments, the metal nanoparticles have diameters greater than 40 nm. In some embodiments, the metal nanoparticles have diameters greater than 30 nm. In some embodiments, the metal nanoparticles have diameters greater than 20 nm. In some embodiments, the metal nanoparticles have diameters greater than 10 nm. In some embodiments, the metal nanoparticles have diameters greater than 9 nm. In some embodiments, the metal nanoparticles have diameters greater than 8 nm. In some embodiments, the metal nanoparticles have diameters greater than 7 nm. In some embodiments, the metal nanoparticles have diameters greater than 6 nm. In some embodiments, the metal nanoparticles have diameters greater than 5 nm. In some embodiments, the metal nanoparticles have diameters greater than 4 nm. In some embodiments, the metal nanoparticles have diameters greater than 3 nm. In some embodiments, the metal nanoparticles have diameters greater than 2 nm. In some embodiments, the metal nanoparticles have diameters greater than 1 nm.

In some embodiments, the mass percentage of the metal nanoparticles in the nanospheres is less than 1%. In some embodiments, the mass percentage of the metal nanoparticles in the nanospheres is less than 2%. In some embodiments, the mass percentage of the metal nanoparticles in the nanospheres is less than 3%. In some embodiments, the mass percentage of the metal nanoparticles in the nanospheres is less than 4%. In some embodiments, the mass percentage of the metal nanoparticles in the nanospheres is less than 5%. In some embodiments, the mass percentage of the metal nanoparticles in the nanospheres is less than 6%. In some embodiments, the mass percentage of the metal nanoparticles in the nanospheres is less than 7%. In some embodiments, the mass percentage of the metal nanoparticles in the nanospheres is less than 8%. In some embodiments, the mass percentage of the metal nanoparticles in the nanospheres is less than 9%. In some embodiments, the mass percentage of the metal nanoparticles in the nanospheres is less than 10%. In some embodiments, the mass percentage of the metal nanoparticles in the nanospheres is less than 15%. In some embodiments, the mass percentage of the metal nanoparticles in the nanospheres is less than 30%. In some embodiments, the mass percentage of the metal nanoparticles in the nanospheres is less than 50%.

In some embodiments, the mass percentage of the metal nanoparticles in the nanospheres is greater than 1%. In some embodiments, the mass percentage of the metal nanoparticles in the nanospheres is greater than 2%. In some embodiments, the mass percentage of the metal nanoparticles in the nanospheres is greater than 3%. In some embodiments, the mass percentage of the metal nanoparticles in the nanospheres is greater than 4%. In some embodiments, the mass percentage of the metal nanoparticles in the nanospheres is greater than 5%. In some embodiments, the mass percentage of the metal nanoparticles in the nanospheres is greater than 6%. In some embodiments, the mass percentage of the metal nanoparticles in the nanospheres is greater than 7%. In some embodiments, the mass percentage of the metal nanoparticles in the nanospheres is greater than 8%. In some embodiments, the mass percentage of the metal nanoparticles in the nanospheres is greater than 9%. In some embodiments, the mass percentage of the metal nanoparticles in the nanospheres is greater than 10%. In some embodiments, the mass percentage of the metal nanoparticles in the nanospheres is greater than 15%. In some embodiments, the mass percentage of the metal nanoparticles in the nanospheres is greater than 30%. In some embodiments, the mass percentage of the metal nanoparticles in the nanospheres is greater than 50%.

### Methods of the Invention

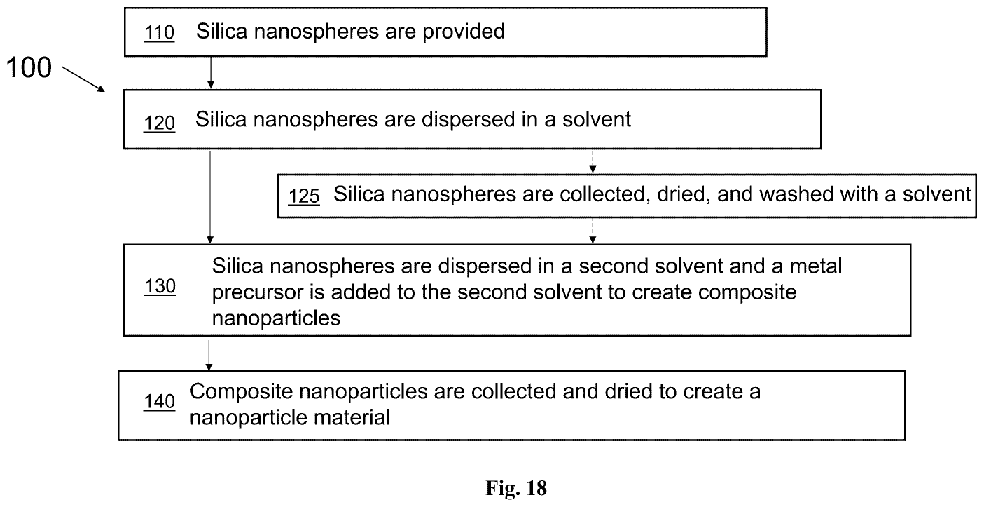

In one aspect, the present invention relates to a method of fabricating a nanoparticle material. Exemplary method 100 is shown in FIG. 18. In step 110, silica nanospheres are provided. In step 120, the silica nanospheres are dispersed in a first solvent. In step 130, the silica nanospheres are dispersed in a second solvent and a metal precursor is added to the second solvent to create composite nanoparticles. In step 140, the composite nanoparticles are collected and dried to create a nanoparticle material. In some embodiments, the silica nanospheres are made of a dielectric material such as that described above. In some embodiments, the silica nanospheres comprise a dielectric material.

In one embodiment, exemplary method 100 further comprises step 125, wherein the silica nanospheres are collected, washed with a solvent, and dried before moving to step 130. In some embodiments, the step of collecting and washing the silica nanospheres further comprises the step of centrifuging the silica nanospheres. Exemplary solvents and aqueous solvents for the first solvent and the second solvent are known in the art. In some embodiments, the second solvent is the same as the first solvent.

In some embodiments, the silica nanospheres that are provided have diameters greater than 1 nm. In some embodiments, the silica nanospheres that are provided have diameters greater than 10 nm. In some embodiments, the silica nanospheres that are provided have diameters greater than 25 nm. In some embodiments, the silica nanospheres that are provided have diameters greater than 50 nm. In some embodiments, the silica nanospheres that are provided have diameters greater than 100 nm. In some embodiments, the silica nanospheres that are provided have diameters greater than 200 nm. In some embodiments, the silica nanospheres that are provided have diameters greater than 300 nm. In some embodiments, the silica nanospheres that are provided have diameters greater than 400 nm. In some embodiments, the silica nanospheres that are provided have diameters greater than 500 nm. In some embodiments, the silica nanospheres that are provided have diameters greater than 750 nm. In some embodiments, the silica nanospheres that are provided have diameters greater than 1000 nm. In some embodiments, the silica nanospheres that are provided have diameters greater than 1200 nm. In some embodiments, the silica nanospheres that are provided have diameters greater than 1500 nm. In some embodiments, the silica nanospheres that are provided have diameters greater than 2000 nm.

In some embodiments, the silica nanospheres that are provided have diameters less than 10 nm. In some embodiments, the silica nanospheres that are provided have diameters less than 25 nm. In some embodiments, the silica nanospheres that are provided have diameters less than 50 nm. In some embodiments, the silica nanospheres that are provided have diameters less than 100 nm. In some embodiments, the silica nanospheres that are provided have diameters less than 200 nm. In some embodiments, the silica nanospheres that are provided have diameters less than 300 nm. In some embodiments, the silica nanospheres that are provided have diameters less than 400 nm. In some embodiments, the silica nanospheres that are provided have diameters less than 500 nm. In some embodiments, the silica nanospheres that are provided have diameters less than 750 nm. In some embodiments, the silica nanospheres that are provided have diameters less than 1000 nm. In some embodiments, the silica nanospheres that are provided have diameters less than 1200 nm. In some embodiments, the silica nanospheres that are provided have diameters less than 1500 nm. In some embodiments, the silica nanospheres that are provided have diameters less than 2000 nm.

In some embodiments, the step of dispersing the silica nanospheres in a first solvent, comprises the step of dispersing the silica nanospheres in an aqueous solvent. In some embodiments, the step of dispersing the silica nanospheres in a first solvent further comprises sonication of the first solvent comprising the silica nanospheres. In some embodiments, the step of dispersing the silica nanospheres in a first solvent, further comprises the step of adding a base or an acid to the first solvent. Dispersing the silica nanospheres in an aqueous solvent with a base or an acid ensures that the surface of the silica nanospheres are enriched in silanol groups.

In some embodiments, the step of dispersing the silica nanospheres in a first solvent, further comprises the step of altering the pH of the first solvent. In some embodiments, the step of dispersing the silica nanospheres in a first solvent, further comprises the step of altering the pH of the first solvent to reach a value between 8 and 13. In some embodiments, the step of altering the pH of the second solvent comprises the step of adding a base or an acid to the first solvent. Altering the pH of the first solvent ensures that the surface of the silica nanospheres is negatively charged and rich in —Si—O— groups. The step of altering the pH of the first solvent further results in the altering of the zeta potentials of the silica nanospheres. As the zeta potential becomes more negative, this indicates that there is an increased coverage of —Si—O— groups on the silica nanospheres.

In some embodiments, the step of altering the pH of the first solvent comprises the step of bringing the pH to a value greater than 5. In some embodiments, the step of altering the pH of the first solvent comprises the step of bringing the pH to a value greater than 6. In some embodiments, the step of altering the pH of the first solvent comprises the step of bringing the pH to a value greater than 7. In some embodiments, the step of altering the pH of the first solvent comprises the step of bringing the pH to a value greater than 8. In some embodiments, the step of altering the pH of the first solvent comprises the step of bringing the pH to a value greater than 9. In some embodiments, the step of altering the pH of the first solvent comprises the step of bringing the pH to a value greater than 10. In some embodiments, the step of altering the pH of the first solvent comprises the step of bringing the pH to a value greater than 11. In some embodiments, the step of altering the pH of the first solvent comprises the step of bringing the pH to a value between 6 and 14. In some embodiments, the step of altering the pH of the first solvent comprises the step of bringing the pH to a value between 7 and 14. In some embodiments, the step of altering the pH of the first solvent comprises the step of bringing the pH to a value between 8 and 13. In some embodiments, the step of altering the pH of the first solvent comprises the step of bringing the pH to a value between 9 and 12. In some embodiments, the step of altering the pH of the first solvent comprises the step of bringing the pH to a value between 10 and 12. In some embodiments, the step of altering the pH of the first solvent comprises the step of bringing the pH to a value between 6 and 8. In some embodiments, the step of altering the pH of the first solvent comprises the step of bringing the pH to a value between 8 and 10. In some embodiments, the step of altering the pH of the first solvent comprises the step of bringing the pH to a value of 11.1.

In some embodiments, the step of altering the pH of the first solvent comprises the step of adding a base or an acid to the first solvent. In some embodiments, the step of adding a base or an acid to the first solvent further comprises the step of heating the solvent. Exemplary bases include, but are not limited to, aqueous ammonia hydroxide (28-30 wt %), ammonium carbonate, ammonium bicarbonate, sodium hydroxide, potassium hydroxide, calcium hydroxide, urea, triethanolamine, triethylamine, sodium ammonium phosphate, ammonium sulfate, magnesium hydroxide, and the like.

Exemplary acids include, but are not limited to, nitric acid, 0.1M nitric acid, hydrochloric acid, phosphoric acid, acetic acid, perchloric acid, citric acid, tartaric acid, oxalic acid, sulfuric acid, formic acid, benzoic acid, sodium hydrogen phosphate, boric acid, acetohydroxamic acid, trichloroacetic acid, iodic acid, lactic acid, malic acid, and the like.

In step 130, the silica nanospheres are dispersed in a second solvent. In some embodiments, the second solvent is an aqueous solvent. In some embodiments, the step of dispersing the silica nanospheres in a second solvent further comprises the step of sonicating the second solvent. In some embodiments, the step of dispersing the silica nanospheres in a second solvent further comprises the step of altering the pH of the second solvent. In some embodiments, the step of altering the pH of the second solvent comprises the step of adding a base or an acid to the second solvent. Exemplary acids and bases are described above. In some embodiments, the step of adding a base or an acid to the second solvent further comprises the step of adding a metal precursor to the second solvent to create composite nanoparticles. In some embodiments, the step of adding a base or an acid to the second solvent further comprises the step of adding more than one metal precursor to the second solvent to create composite nanoparticles. In some embodiments, composite nanoparticles comprise metal oxyhydride/silica nanoparticles and have the general formula of MO_{y}(OH)_{z}/SiOₓ. In some embodiments, composite nanoparticles comprise nanospheres with metal nanoparticles coating the surface of the silica nanospheres. In some embodiments, composite nanoparticles comprise metal nanoparticles anchored to the surface of the silica nanoparticles through metal silane bonds. In some embodiments, the steps of dispersing the silica nanospheres in a second solvent, altering the pH of the second solvent, and adding a metal precursor to create composite nanoparticles, further comprises the step of anchoring the metal precursors to the surface of the silica nanospheres through metal-silane bonds.

In some embodiments, the metal precursors are in the form of metal salts. In some embodiments, the metal precursors are water soluble. In some embodiments, the metal precursors are in the form of aqueous solutions. Exemplary metal precursors include, but are not limited to, manganese(II) nitrate hydrate (Mn(NO₃)₂·xH₂O), Iron(II) chloride (FeCl₂), cobalt(II) nitrate hexahydrate (Co(NO₃)₂·6H₂O), nickel(II) nitrate hexahydrate (Ni(NO₃)₂·6H₂O), copper(II) nitrate trihydrate (Cu(NO₃)₂·3H₂O), ruthenium(III) chloride hydrate (RuCl₃·xH₂O), sodium tetrachloropalladate(II) hydrate (Na₂PdCl₄·xH₂O), sodium hexachlororhodate(III) hydrate (Na₃RhCl₆·xH₂O), tetrachloroauric(III) acid trihydrate (HAuCl₄·3H₂O), sodium tetrachloroplatinate(II) hydrate (Na₂PtCl₄·xH₂O), potassium tetrachloroplatinate(II) hydrate (K₂PtCl₄·xH₂O), sodium hexachloroplatinate (Na₄PtCl₆), potassium hexachloroplatinate (K₄PtCl₆), magnesium chloride (MgCl₂), aluminum nitrate nonahydrate (Al(NO₃)₂·9H₂O), zinc nitrate hexahydrate (Zn(NO₃)₂·6H₂O), and combinations thereof.

Different metal precursors require different pH values for successful deposition on silica nanospheres and thus altering the pH of the second solvent ensures that successful deposition occurs between the metal precursor and the silica nanospheres.

In some embodiments, the step of altering the pH of the second solvent comprises the step of bringing the pH to a value greater than 5. In some embodiments, the step of altering the pH of the second solvent comprises the step of bringing the pH to a value greater than 6. In some embodiments, the step of altering the pH of the second solvent comprises the step of bringing the pH to a value greater than 7. In some embodiments, the step of altering the pH of the second solvent comprises the step of bringing the pH to a value greater than 8. In some embodiments, the step of altering the pH of the second solvent comprises the step of bringing the pH to a value greater than 9. In some embodiments, the step of altering the pH of the second solvent comprises the step of bringing the pH to a value greater than 10. In some embodiments, the step of altering the pH of the second solvent comprises the step of bringing the pH to a value greater than 11. In some embodiments, the step of altering the pH of the second solvent comprises the step of bringing the pH to a value between 5 and 14. In some embodiments, the step of altering the pH of the second solvent comprises the step of bringing the pH to a value between 6 and 14. In some embodiments, the step of altering the pH of the second solvent comprises the step of bringing the pH to a value between 7 and 14. In some embodiments, the step of altering the pH of the second solvent comprises the step of bringing the pH to a value between 8 and 13. In some embodiments, the step of altering the pH of the second solvent comprises the step of bringing the pH to a value between 9 and 12. In some embodiments, the step of altering the pH of the second solvent comprises the step of bringing the pH to a value between 10 and 12. In some embodiments, the step of altering the pH of the second solvent comprises the step of bringing the pH to a value between 6 and 8. In some embodiments, the step of altering the pH of the second solvent comprises the step of bringing the pH to a value between 8 and 10. In some embodiments, the step of altering the pH of the second solvent comprises the step of bringing the pH to a value of 11.1.

In some embodiments, the step of adding a metal precursor to the second solvent comprises adding more than one type of metal precursor to the second solvent. In some embodiments, the step of adding more than one type of metal precursor to the second solvent comprises adding two metal precursors with metal ratios between 1:99 and 99:1. In some embodiments, the step of adding more than one type of metal precursor to the second solvent comprises adding two metal precursors with metal ratios between 1:50 and 50:1. In some embodiments, the step of adding more than one type of metal precursor to the second solvent comprises adding two metal precursors with metal ratios between 1:20 and 20:1. In some embodiments, the step of adding more than one type of metal precursor to the second solvent comprises adding two metal precursors with metal ratios between 1:10 and 10:1. In some embodiments, the step of adding more than one type of metal precursor to the second solvent comprises adding two metal precursors with metal ratios between 1:5 and 5:1. In some embodiments, the step of adding more than one type of metal precursor to the second solvent comprises adding two metal precursors with metal ratios between 1:4 and 2:1. In some embodiments, the metal precursors comprise metals described above. In some embodiments, the step of adding a metal precursor to the second solvent further comprises the step of heating the second solvent.

In some embodiments, the step of adding a metal precursor comprises the step of adding an aqueous metal precursor solution containing less than 1.0 wt. % of metal. In some embodiments, the step of adding a metal precursor comprises the step of adding an aqueous metal precursor solution containing less than 2.0 wt. % of metal. In some embodiments, the step of adding a metal precursor comprises the step of adding an aqueous metal precursor solution containing less than 3.0 wt. % of metal. In some embodiments, the step of adding a metal precursor comprises the step of adding an aqueous metal precursor solution containing less than 4.0 wt. % of metal. In some embodiments, the step of adding a metal precursor comprises the step of adding an aqueous metal precursor solution containing less than 5.0 wt. % of metal. In some embodiments, the step of adding a metal precursor comprises the step of adding an aqueous metal precursor solution containing less than 6.0 wt. % of metal. In some embodiments, the step of adding a metal precursor comprises the step of adding an aqueous metal precursor solution containing less than 7.0 wt. % of metal. In some embodiments, the step of adding a metal precursor comprises the step of adding an aqueous metal precursor solution containing less than 8.0 wt. % of metal. In some embodiments, the step of adding a metal precursor comprises the step of adding an aqueous metal precursor solution containing less than 9.0 wt. % of metal. In some embodiments, the step of adding a metal precursor comprises the step of adding an aqueous metal precursor solution containing less than 10.0 wt. % of metal. In some embodiments, the step of adding a metal precursor comprises the step of adding an aqueous metal precursor solution containing less than 15.0 wt. % of metal. In some embodiments, the step of adding a metal precursor comprises the step of adding an aqueous metal precursor solution containing less than 30.0 wt. % of metal. In some embodiments, the step of adding a metal precursor comprises the step of adding an aqueous metal precursor solution containing less than 50.0 wt. % of metal.

In some embodiments, the step of adding a metal precursor comprises the step of adding an aqueous metal precursor solution containing greater than 0.1 wt. % of metal. In some embodiments, the step of adding a metal precursor comprises the step of adding an aqueous metal precursor solution containing greater than 1.0 wt. % of metal. In some embodiments, the step of adding a metal precursor comprises the step of adding an aqueous metal precursor solution containing greater than 2.0 wt. % of metal. In some embodiments, the step of adding a metal precursor comprises the step of adding an aqueous metal precursor solution containing greater than 3.0 wt. % of metal. In some embodiments, the step of adding a metal precursor comprises the step of adding an aqueous metal precursor solution containing greater than 4.0 wt. % of metal. In some embodiments, the step of adding a metal precursor comprises the step of adding an aqueous metal precursor solution containing greater than 5.0 wt. % of metal. In some embodiments, the step of adding a metal precursor comprises the step of adding an aqueous metal precursor solution containing greater than 6.0 wt. % of metal. In some embodiments, the step of adding a metal precursor comprises the step of adding an aqueous metal precursor solution containing greater than 7.0 wt. % of metal. In some embodiments, the step of adding a metal precursor comprises the step of adding an aqueous metal precursor solution containing greater than 8.0 wt. % of metal. In some embodiments, the step of adding a metal precursor comprises the step of adding an aqueous metal precursor solution containing greater than 9.0 wt. % of metal. In some embodiments, the step of adding a metal precursor comprises the step of adding an aqueous metal precursor solution containing greater than 10.0 wt. % of metal. In some embodiments, the step of adding a metal precursor comprises the step of adding an aqueous metal precursor solution containing greater than 15.0 wt. % of metal. In some embodiments, the step of adding a metal precursor comprises the step of adding an aqueous metal precursor solution containing greater than 30.0 wt. % of metal. In some embodiments, the step of adding a metal precursor comprises the step of adding an aqueous metal precursor solution containing greater than 50.0 wt. % of metal.

In some embodiments, the composite nanoparticles created in step 130 comprise metal nanoparticles with diameters less than 200 nm. In some embodiments, the composite nanoparticles created in step 130 comprise metal nanoparticles with diameters less than 100 nm. In some embodiments, the composite nanoparticles created in step 130 comprise metal nanoparticles with diameters less than 90 nm. In some embodiments, the composite nanoparticles created in step 130 comprise metal nanoparticles with diameters less than 80 nm. In some embodiments, the composite nanoparticles created in step 130 comprise metal nanoparticles with diameters less than 70 nm. In some embodiments, the composite nanoparticles created in step 130 comprise metal nanoparticles with diameters less than 60 nm. In some embodiments, the composite nanoparticles created in step 130 comprise metal nanoparticles with diameters less than 50 nm. In some embodiments, the composite nanoparticles created in step 140 comprise metal nanoparticles with diameters less than 40 nm. In some embodiments, the composite nanoparticles created in step 130 comprise metal nanoparticles with diameters less than 30 nm. In some embodiments, the composite nanoparticles created in step 130 comprise metal nanoparticles with diameters less than 20 nm. In some embodiments, the composite nanoparticles created in step 130 comprise metal nanoparticles with diameters less than 10 nm. In some embodiments, the composite nanoparticles created in step 130 comprise metal nanoparticles with diameters less than 9 nm. In some embodiments, the composite nanoparticles created in step 140 comprise metal nanoparticles with diameters less than 8 nm. In some embodiments, the composite nanoparticles created in step 130 comprise metal nanoparticles with diameters less than 7 nm. In some embodiments, the composite nanoparticles created in step 130 comprise metal nanoparticles with diameters less than 6 nm. In some embodiments, the composite nanoparticles created in step 130 comprise metal nanoparticles with diameters less than 5 nm. In some embodiments, the composite nanoparticles created in step 130 comprise metal nanoparticles with diameters less than 4 nm. In some embodiments, the composite nanoparticles created in step 130 comprise metal nanoparticles with diameters less than 3 nm. In some embodiments, the composite nanoparticles created in step 130 comprise metal nanoparticles with diameters less than 2 nm. In some embodiments, the composite nanoparticles created in step 130 comprise metal nanoparticles with diameters less than 1 nm.

In some embodiments, the composite nanoparticles created in step 130 comprise metal nanoparticles with diameters greater than 200 nm. In some embodiments, the composite nanoparticles created in step 130 comprise metal nanoparticles with diameters greater than 100 nm. In some embodiments, the composite nanoparticles created in step 130 comprise metal nanoparticles with diameters greater than 90 nm. In some embodiments, the composite nanoparticles created in step 130 comprise metal nanoparticles with diameters greater than 80 nm. In some embodiments, the composite nanoparticles created in step 130 comprise metal nanoparticles with diameters greater than 70 nm. In some embodiments, the composite nanoparticles created in step 130 comprise metal nanoparticles with diameters greater than 60 nm. In some embodiments, the composite nanoparticles created in step 130 comprise metal nanoparticles with diameters greater than 50 nm. In some embodiments, the composite nanoparticles created in step 130 comprise metal nanoparticles with diameters greater than 40 nm. In some embodiments, the composite nanoparticles created in step 130 comprise metal nanoparticles with diameters greater than 30 nm. In some embodiments, the composite nanoparticles created in step 130 comprise metal nanoparticles with diameters greater than 20 nm. In some embodiments, the composite nanoparticles created in step 130 comprise metal nanoparticles with diameters greater than 10 nm. In some embodiments, the composite nanoparticles created in step 130 comprise metal nanoparticles with diameters greater than 9 nm. In some embodiments, the composite nanoparticles created in step 130 comprise metal nanoparticles with diameters greater than 8 nm. In some embodiments, the composite nanoparticles created in step 130 comprise metal nanoparticles with diameters greater than 7 nm. In some embodiments, the composite nanoparticles created in step 130 comprise metal nanoparticles with diameters greater than 6 nm. In some embodiments, the composite nanoparticles created in step 130 comprise metal nanoparticles with diameters greater than 5 nm. In some embodiments, the composite nanoparticles created in step 130 comprise metal nanoparticles with diameters greater than 4 nm. In some embodiments, the composite nanoparticles created in step 130 comprise metal nanoparticles with diameters than 3 nm. In some embodiments, the composite nanoparticles created in step 130 comprise metal nanoparticles with diameters than 2 nm. In some embodiments, the composite nanoparticles created in step 130 comprise metal nanoparticles with diameters greater than 1 nm.

In step 140, the composite nanoparticles are collected and dried to create a nanoparticle material. In some embodiments, the step of collecting and drying the composite nanoparticles further comprises the step of centrifuging and washing the composite nanoparticles. In some embodiments, the step of collecting and drying the composite nanoparticles further comprises the step of reducing composite nanoparticles. Reducing the composite nanoparticles reduces the metal oxyhydroxide nanoparticles on the silica spheres by reducing the metal oxyhydroxide nanoparticles to their metallic state. In some embodiments, the step of reducing the composite particles alters the size of the metal nanoparticles to a diameter described above.

In some embodiments, the step of reducing the composite nanoparticles comprises the step of thermally reducing the composite nanoparticles. In some embodiments, the step of thermally reducing composite nanoparticles is done at a temperature above 50° C. In some embodiments, the step of thermally reducing the composite nanoparticles is done at a temperature above 100° C. In some embodiments, the step of thermally reducing composite nanoparticles is done at a temperature above 200° C. In some embodiments, the step of thermally reducing the composite nanoparticles is done at a temperature above 300° C. In some embodiments, the step of thermally reducing the composite nanoparticles is done at a temperature above 400° C. In some embodiments, the step thermally reducing the composite nanoparticles is done at a temperature above 500° C. In some embodiments, the step of thermally reducing the composite nanoparticles is done at a temperature above 600° C. In some embodiments, the step of thermally reducing the composite nanoparticles is done at a temperature above 700° C. In some embodiments, the step of thermally reducing the composite nanoparticles is done at a temperature above 800° C.

In some embodiments, the step of thermally reducing the composite nanoparticles is done at a temperature below 50° C. In some embodiments, the step of thermally reducing the composite nanoparticles is done at a temperature below 100° C. In some embodiments, the step of thermally reducing the composite nanoparticles is done at a temperature below 200° C. In some embodiments, the step of thermally reducing the composite nanoparticles is done at a temperature below 300° C. In some embodiments, the step of thermally reducing the composite nanoparticles is done at a temperature below 400° C. In some embodiments, the step of thermally reducing the composite nanoparticles is done at a temperature below 500° C. In some embodiments, the step of thermally reducing the composite nanoparticles is done at a temperature below 600° C. In some embodiments, the step of thermally reducing the composite nanoparticles is done at a temperature below 700° C. In some embodiments, the step of thermally reducing the composite nanoparticles is done at a temperature below 800° C.

In some embodiments, the step of conducting a thermal reduction of the composite nanoparticles comprises the step of contacting the composite nanoparticles with a flow of H₂ gas. In some embodiments, the step of conducting a thermal reduction of the composite nanoparticles comprises the step of contacting the composite nanoparticles with a flow of 5% H₂/N₂ gas. In some embodiments, the flow rate of the 5% H₂/N₂ gas is controlled to a desirable flow rate.

In some embodiments, the step of reducing the composite nanoparticles further comprises the step of coating the composite nanoparticles with a dielectric material coating. In some embodiments, the dielectric material coating comprises a dielectric material described above. In some embodiments, the dielectric material coating is less than 100 nm thick. In some embodiments, the dielectric material coating is less than 90 nm thick. In some embodiments, the dielectric material coating is less than 80 nm thick. In some embodiments, the dielectric material coating is less than 70 nm thick. In some embodiments, the dielectric material coating is less than 60 nm thick. In some embodiments, the dielectric material coating is less than 50 nm thick. In some embodiments, the dielectric material coating is less than 40 nm thick. In some embodiments, the dielectric material coating is less than 30 nm thick. In some embodiments, the dielectric material coating is less than 20 nm thick. In some embodiments, the dielectric material coating is less than 10 nm thick. In some embodiments, the dielectric material coating is less than 9 nm thick. In some embodiments, the dielectric material coating is less than 8 nm thick. In some embodiments, the dielectric material coating is less than 7 nm thick. In some embodiments, the dielectric material coating is less than 6 nm thick. In some embodiments, the dielectric material coating is less than 5 nm thick. In some embodiments, the dielectric material coating is less than 4 nm thick. In some embodiments, the dielectric material coating is less than 3 nm thick. In some embodiments, the dielectric material coating is less than 2 nm thick.

### EXPERIMENTAL EXAMPLES

The invention is now described with reference to the following Examples. These Examples are provided for the purpose of illustration only, and the invention is not limited to these Examples, but rather encompasses all variations that are evident as a result of the teachings provided herein.

### Example 1: Ultrafine Metal Nanoparticle/Spherical Silica Composite Particles

Ultrafine metal nanoparticles (ufMNPs) with sizes below 5 nm represent a class of widely used catalysts due to their high surface-to-volume ratios and profound electron dislocation upon interaction with surface adsorbates. In addition to traditional thermal catalysis, ufMNPs can absorb photoenergy to generate hot electrons that can transfer energy to surface adsorbates and promote surface reactions. Hot electron generation originates from the decay of excited surface plasmons, and the efficiency of generating high-energy hot electrons becomes higher with the decrease in nanoparticle size. Nevertheless, the light absorption power of ufMNPs lowers as the nanoparticles become smaller, preventing the ufMNPs from being used as efficient photocatalysts. Integrating ufMNPs with light antenna materials has been demonstrated to be a promising solution to improve the optical absorption power of the ufMNPs. Metal nanoparticles with strong localized surface plasmon resonances (LSPRs) (e.g., Au, Ag, Cu, and Al nanoparticles) and dielectric spheres with strong optical surface scattering resonances represent two types of light antenna, which can concentrate the incident photoenergy to enhance electric fields near the antenna's surface locally. Using plasmonic metal nanoparticle antennae usually requires delicate synthesis to create a dielectric separation layer with a precise thickness of 1-5 nm between the antenna nanoparticles and catalyst ufMNPs. A thick separation layer decays the electric field significantly for the ufMNPs, while a too thin separation could cause a charge flow between the antenna nanoparticles and the ufMNPs. In contrast, the catalyst ufMNPs can be directly dispersed on dielectric spheres without suffering from weakened electric fields and interparticle charge flow, allowing the ufMNPs to benefit the antenna effect fully. For example, nanoparticles made of noble metals and compounds loaded on silica spheres with diameters in the range of 200-1200 nm have been shown to exhibit enhanced optical absorption, particularly in the visible spectral range compared to the freestanding nanoparticles, along with characteristic absorption peaks determined by the surface scattering resonance bands of the silica spheres. It is necessary to develop a general method to load ufMNPs of varying compositions on silica spheres to maximize the antenna effect in boosting the photocatalytic performance of the ufMNPs (Hartland, G. V. et al., ACS Energy Letters 2017, 2, 1641-1653; Stewart, S. et al., Chemical Science 2021, 12, 1227-1239; Wei, Q. et al., Advanced Materials 2018, 30, 1802082; Besteiro, L. V. et al., The Journal of Physical Chemistry C 2016, 120, 19329-19339; Brongersma, M. L. et al., Nature Nanotechnology 2015, 10, 25-34; Rasamani, K. D. and Sun, Y., The Journal of Chemical Physics 2020, 152, 084706; Yuan, Y. et al., Science 2022, 378, 889-893; Yuan, L. et al., ACS Nano 2022, 16, 17365-17375; Swearer, D. F. et al., Proceedings of the National Academy of Sciences 2016, 113, 8916-8920; Zhang, N. et al., Nature Photonics 2016, 10, 473-482; Rasamani, K. D. et al., Nano Futures 2018, 2, 015003; Dai, X. et al., ChemNanoMat 2019, 5, 1000-1007; Wei, Q. et al., Nano-Micro Letters 2020, 12, 41; Wei, Q. et al., The Journal of Physical Chemistry C 2022, 126, 17997-18005; Dai, X.; Sun, Y., Nanoscale Horizons 2024. DOI 10.1039/D3NH00506B).

The most common method used in the chemical industry is the impregnation method, which is based on the loading of metal precursors onto the support material, followed by treatments to obtain final products. The loading can be conducted in both dry and wet conditions. For example, to load platinum (Pt) precursors onto porous silica supports, one can mix a certain amount of Pt precursor solution with silica powder with thorough mixing or disperse silica powder in a larger amount of precursor solution followed by solvent evaporation. The obtained metal-loaded powders are fully dried in the oven, and metal or metal oxyhydroxide can be obtained by treating the sample with hydrogen gas or air. Since this method relies on the adsorption of metal precursors in the pores in support materials, the obtained nanoparticle morphology is hard to be controlled. If the study is related to the effect of nanoparticle sizes, morphologies and crystallinity, nanoparticles can be synthesized separately in the solution phase, followed by loading onto the surface of support materials through adsorption or other surface interactions (e.g., electrostatic interactions). Furthermore, in order to obtain stronger interaction between the loaded metal species and the support, the metal ions can be loaded first to the support followed by a separate reduction process. The support materials are usually functionalized by organic linkers, on which one side is grafted to the support, and the other side can interact with free-standing metal ions. The interaction between the metal ion and the support prepared using this method is more direct since no surfactant is involved, and can result in higher thermal stabilities during the application (Deng, L. et al., Chem. Commun. 2017, 53, 6937-6940; Chen, H. et al., ChemCatChem 2019, 11, 3542-3551; Khdary, N. H.; Ghanem, M., RSC Adv. 2014, 4, 50114-50122; Hutchings, G. J. and Vedrine, J. C. Heterogeneous Catalyst Preparation; Springer Ser. Chem. Phys. 2004, 215-258; van de Water, L. G. A. et al., J. Am. Chem. Soc. 2005, 127, 5024-5025; Zhang, Q. et al., Metal Sites in Zeolites: Synthesis, Characterization, and Catalysis. Chem. Rev. 2022; Muthuchamy, N. et al., RSC Adv. 2015, 5, 76170-76181; Pei, Y. et al., Surf. Sci. 2016, 648, 299-306; Grigoropoulou, G. et al., Colloids Surf., A 2008, 320, 25-35; Ding, Y. et al., Appl. Catal., B 2017, 203, 372-380; Rice, D. et al., ACS Omega 2018, 3, 13028-13035).

Loading ufMNPs on silica spheres is currently realized through either electrostatic assembly of negatively charged colloidal ufMNPs on silane-functionalized silica spheres or in-situ reduction of metal ion precursors in the presence of colloidal silica spheres. Despite the success in loading ufMNPs of some noble metal elements, the quality and composition scope of the ufMNPs are yet to improve significantly. For instance, the former electrostatic assembly strategy is limited by the difficulty in synthesizing high-quality colloidal ufMNPs nanoparticles made of a wide range of compositions, particularly non-noble metals, in an aqueous (and/or ethanolic) solution phase, which is necessary for dispersing the surface-functionalized silica spheres. In addition, the organic silane reagents used for surface functionalization of the silica spheres and the capping agents used for synthesizing ufMNPs could adversely influence thermal stability and catalytic performance. These surface organic species may undergo thermal/photocatalytic decomposition, particularly in gas-phase reactions, to pollute the catalytic reaction products. The latter in-situ reduction strategy often suffers from the simultaneous homogeneous and heterogeneous nucleation that leads to nonuniform loading, broad size distribution, and agglomeration of ufMNPs. Although excluding surface species in the resulting composite particles favors thermal stability and catalysis, uniformly controlled deposition of metal contents on silica spheres is still challenging (Li, D. et al., ACS Catalysis 2012, 2, 1358-1362; Lee, I. et al., Nano Research 2011, 4, 115-123; Carneiro, L. et al., Catalysis Science & Technology 2016, 6, 8166-8176; Li, X. et al., RSC Advances 2015, 5, 69962-69969; Ataee-Esfahani, H. et al., Chemical Communications 2011, 47, 3885-3887; Gude, K. et al., The Journal of Physical Chemistry C 2010, 114, 6356-6362).

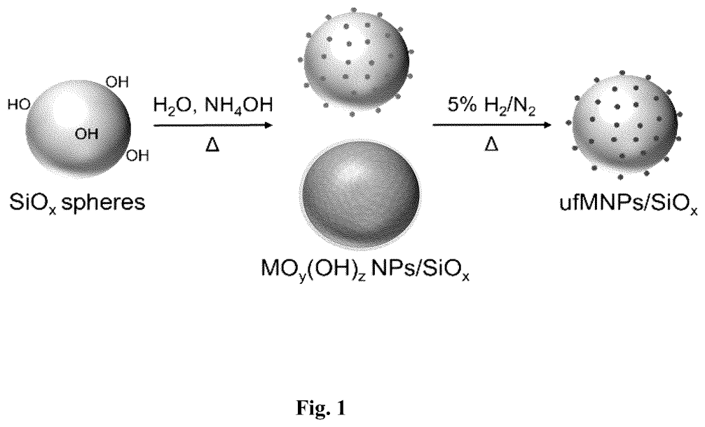

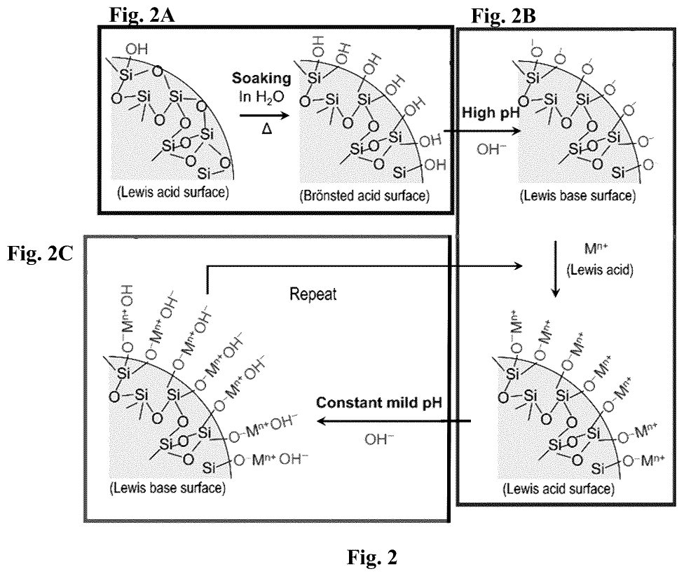

Herein is a general synthesis protocol involving two steps, i.e., uniform deposition of metal hydroxide on silica nanospheres (SiOₓ NSs) with a controlled manner at appropriate solution pH values followed by a thermal reduction in forming gas (5% H₂+95% N₂) at elevated temperatures (FIG. 1). Because metal precursor ions tend to hydrolyze or precipitate with hydroxide anions, the solution pH value should be carefully controlled to avoid homogeneous nucleation of metal hydroxide in the solution. On the other hand, the surface of SiOₓ NSs should exhibit stronger basicity that favors reaction with metal cations (i.e., a type of Lewis acid) to selectively deposit metal hydroxide on the SiOₓ NSs through heterogeneous nucleation. FIG. 2 summarizes the major steps of the “surface acid-base reaction” strategy that can uniformly load precursor metal cations to the SiOₓ NSs in the form of metal hydroxide. The SiOₓ NSs with the dehydrated surface (i.e., —Si—O—Si— termination group) or partially hydrated surface are incubated in hot (or warm) water to generate a highly hydrated surface that is terminated with a high density of —Si—OH group (FIG. 2A). This process converts the nonuniform surface from the Lewis acid-dominated characteristics to the uniform Brönsted acid characteristics. Dispersing the SiOₓ NSs in a solution at an appropriate pH leads to the surface acid-base reaction between the surface —Si—OH group (Brönsted acid) and freestanding OH⁻ ions (Brönsted base), transforming the surface to —Si—O⁻ groups with Lewis base characteristics. A high pH value with a high concentration of freestanding OH⁻ ions in the solution is usually required to fully convert the SiOₓ NS's surface to the uniform Lewis base surface (FIG. 2B). In the presence of low-concentration metal cations (M^{m+}) exhibiting Lewis acid characteristics, the surface acid-base reaction between M^{m+} and —Si—O⁻ loads the metal cations onto the SiOₓ NSs. Such heterogeneous loading of M^{m+} on the SiOₓ surface may compete with the homogeneous acid-base reaction between M^{m+} and freestanding OH⁻ (both Brönsted and Lewis base characteristics) that possibly occurs to form metal hydroxide particles in solution when the concentration of M^{m+} is high in a high-pH solution. Therefore, it is critical to control an appropriately high pH of the solution and an appropriately low concentration of M^{m+} that enables only the acid-base reaction on the surface of the SiOₓ NSs but prevents the homogeneous acid-base reaction in the solution. In general, the local concentration of —Si—O⁻ on the surface of SiOₓ NSs can be many orders higher than the concentration of freestanding OH⁻ in the solution. The locally concentrated —Si—O⁻ group makes the SiOₓ NS's surface exhibit much stronger basicity than the solution containing OH⁻ ions. The difference in basicity between the SiOₓ NS's surface and the solution favors the surface acid-base reaction on the SiOₓ NSs to load metal cations onto the SiOₓ NSs. The loading of metal cations changes the NS's surface to the Lewis acid characteristics, which will then react with freestanding OH⁻ ions. This reaction switches the NS's surface to the Lewis base characteristics. The alternating switch of surface property between the Lewis base and Lewis acid drives the continuous loading of M^{m+} cations and OH⁻ anions to the surface of the SiOₓ NSs (FIG. 2C). As a result, both M^{m+} and OH⁻ ions are loaded to the SiOₓ NS's surface, which is equivalent to metal hydroxide [M(OH)ₘ] or metal oxyhydroxide [MO_{y}(OH)_{z}] for the thin deposition. The more general formula MO_{y}(OH)_{z} will be used in the following content without specific notification. For example, Ru(III) ions have been deposited on SiOₓ NSs at an appropriate pH to form RuOOH nanoparticles (NPs) of 1-2 nm in size that uniformly disperse on the SiOₓ NS's surface.^{[13]} Although the alternating deposition of M^{m+} and OH⁻ ions through “surface acid-base reaction” is similar to the result of an “electrochemical double layer” around a charged surface, the surface acid-base reaction forms a layer of ions with a much higher density due to the significantly lowered solubility of MO_{y}(OH)_{z}, ensuring the appropriate loading of precursor metal cations. Note: Describing the continuous acid-base reaction in a layer-by-layer fashion is to enhance the clarity, but the actual surface reaction could be instantaneous due to the fast reaction kinetics.

### Results and Discussions

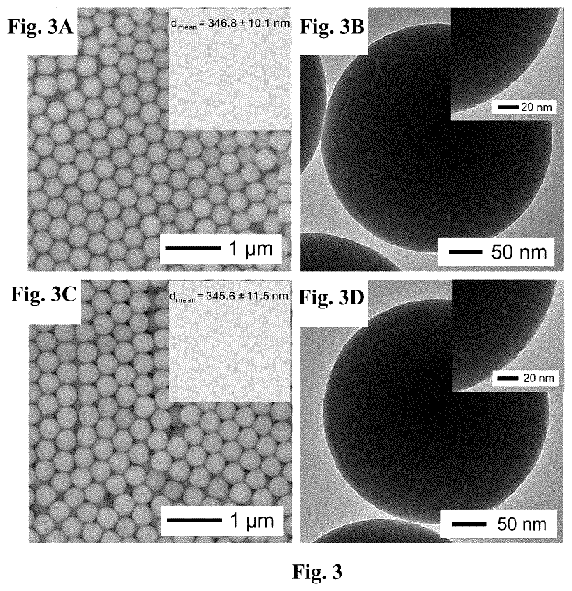

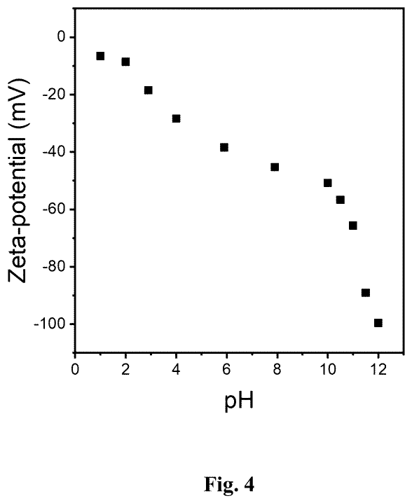

The method produces highly monodisperse SiOₓ NSs with an average diameter of 346.8 nm (FIG. 3A). Transmission electron microscopy (TEM) images of individual SiOₓ NSs show their smooth surfaces (FIG. 3B). Previous work has demonstrated that the smooth surfaces of the as-synthesized SiOₓ NSs cannot stabilize metal hydroxide or metal oxyhydroxide due to the lack of hydroxyl groups on the SiOₓ NS's surface. A controlled surface treatment is employed to generate high-density surface —Si—O⁻ groups through the hydrolysis reaction shown in FIG. 1A and surface acid-base reaction with NH₄OH aqueous solution. FIG. 3C presents the SiOₓ NSs with rich —Si—O⁻ groups prepared in a solution with a pH value of 11.10, indicating that their high spherical symmetry and size uniformity are maintained. As expected, the surface treatment results in slight surface roughness (FIG. 3D) and variation of zeta potential. The as-synthesized SiOₓ NSs usually present zeta potentials of −38˜−45 mV in deionized water (DI H₂O). Suspending the SiOₓ NSs in an aqueous solution containing different concentrations of NH₄OH or nitric acid results in different zeta potentials over a wide range (FIG. 4). When the solution is acidified, the zeta potential decreases and converges to near zero at a low enough pH. As the pH value of the solution increases, the zeta potential of the SiOₓ NSs becomes more negative, indicating the increased coverage of surface —Si—O⁻ groups (Alexander, G. B. et al., The Journal of Physical Chemistry 1954, 58, 453-455; Kato, K. and Kitano, Y., Journal of the Oceanographical Society of Japan 1968, 24, 147-152; Wilhelm, P. and Stephan, D., Journal of Colloid and Interface Science 2006, 293, 88-92).

The SiOₓ NSs with rich —Si—O⁻ groups are utilized to anchor metal ions through surface acid-base reaction between metal cations and hydroxide anions (FIG. 1C). Different metal cations exist as different metal aquo complexes [M(H₂O)ₙ^{m+}] in aqueous solution and exhibit different acidities due to the electronic effect and thus the reactivity/affinity to the surface —Si—O⁻ groups, influencing the nucleation step. The acidity of surface-fixed metal cations determines the reactivity with OH⁻, which supports the continuous deposition of metal cations. Therefore, successful loading of different types of metal ions should be conducted by controlling solution pH at appropriate values and reaction temperatures. Harsh conditions, including high pH and temperature, will result in rapid reactions with a loose control over the deposition kinetics of MO_{y}(OH)_{z}, leading to the formation of a nonuniform coating on the surfaces of SiOₓ NSs. Therefore, optimizing the reaction conditions requires screening the pH value of the reaction solution and reaction temperature. The optimized conditions of various metal ions explored in this work are summarized below in Table 1 (Hawkes, S. J., Journal of Chemical Education 1996, 73, 516).

TABLE 1
Optimized conditions for synthesizing
ufMNPs/SiOₓ composite particles.

| | | | Deposition | Reduction |
|---|---|---|---|---|
| | | Deposition pH | temperature | temperature |
| Element | Precursor | value | (° C.) | (° C.) |
| Mn | Mn(NO₃)₂•xH₂O | 10.15 | 25 | 550 |
| Fe | FeCl₂ | 8.90 | 25 | 550 |
| Co | Co(NO₃)₂•6H₂O | 9.63 | 25 | 550 |
| Ni | Ni(NO₃)₂•6H₂O | 10.15 | 25 | 550 |
| Cu | Cu(NO₃)₂•3H₂O | 10.17 | 25 | 250 |
| Ru^{a} | RuCl₃•xH₂O | 8.90 | 25 | 250 |
| Pd | Na₂PdCl₄•xH₂O | 8.90 | 25 | 250 |
| Rh | Na₃RhCl₆•xH₂O | 6.35 | 60 | 250 |
| Au | HAuCl₄•3H₂O | 10.20 | 60 | 250 |
| Pt | Na₂PtCl₄•xH₂O | 12.90 | 60 | 250 |
| Mg | MgCl₂ | 11.85 | 25 | NA |
| AI | Al(NO₃)₂•9H₂O | 8.90 | 25 | NA |
| Zn | Zn(NO₃)₂•6H₂O | 10.15 | 25 | NA |
| CuNi | Cu(NO₃)₂•3H₂O | 10.15 | 25 | 550 |
| | Ni(NO₃)₂•6H₂O | | | |
| RuPd | RuCl₃•xH₂O | 8.90 | 25 | 250 |
| | Na₂PdCl₄•xH₂O | | | |

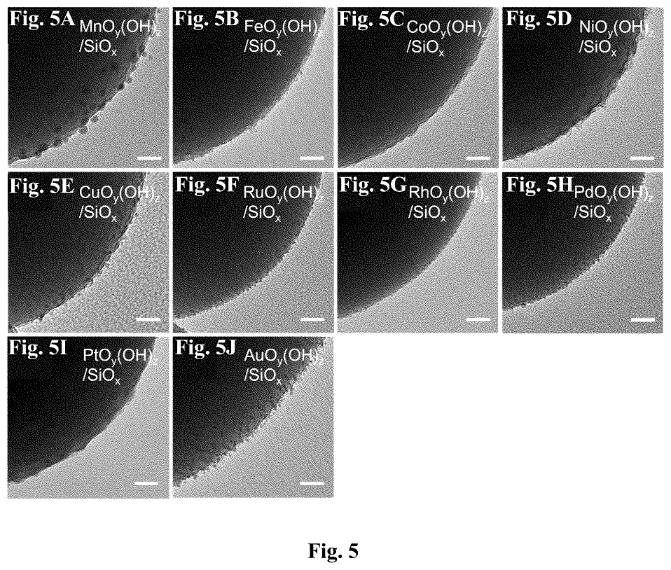

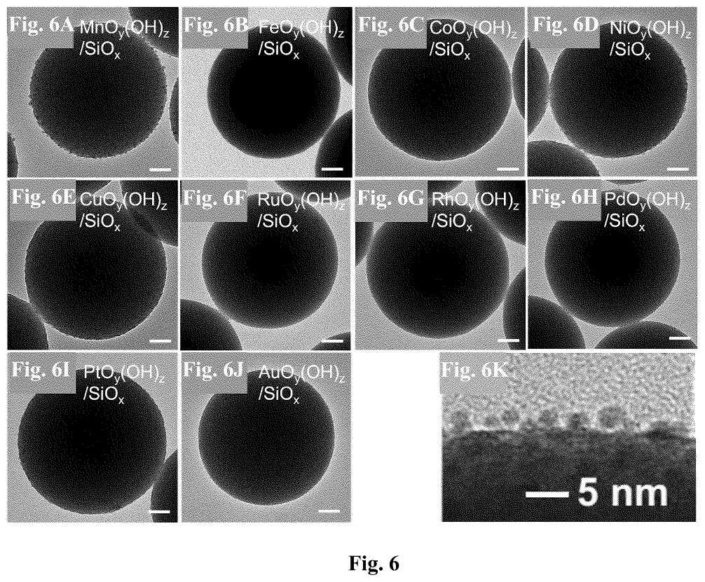

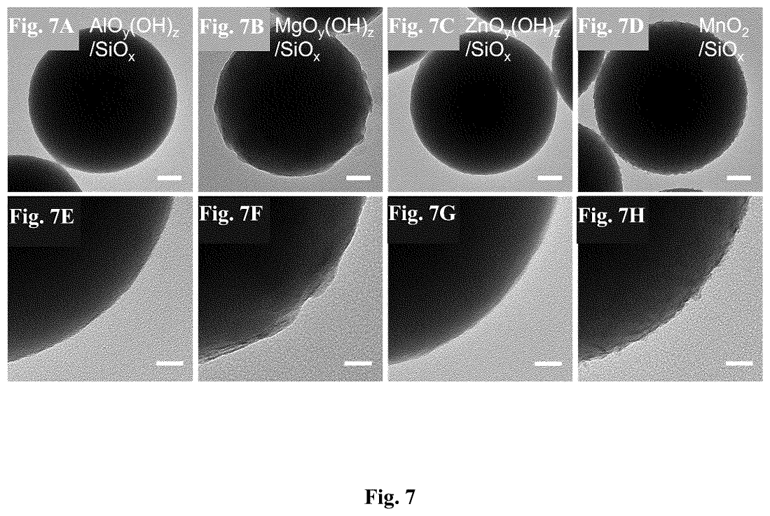

Under these conditions, precious metal ions [Ru(III), Rh(III), Pd(II), Pt(II), Au(III)], 3d block transition metal ions [Mn(II), Fe(III), Co(II), Ni(II), Cu(II), Zn(II)], 3p block metal ions [Al(III)], 3s block metal ions [Mg(II)], and their combinations are successfully loaded onto the surface of SiOₓ NSs, confirmed by inductively coupled plasma-optical emission spectrometry (ICP-OES). The resulting composite particles of SiOₓ NSs with thin MO_{y}(OH)_{z} coverage are characterized with TEM imaging (FIG. 5, FIG. 6, and FIG. 7), showing the uniform distribution of MO_{y}(OH)_{z} with different morphologies for different metal ions. The morphological difference originates from the different wettability of MO_{y}(OH)_{z} towards the SiOₓ NS surface and the different formation enthalpy of MO_{y}(OH)_{z}. Strong wettability to the silica surface results in the formation of the film-like coating, including FeO_{y}(OH)_{z}, CoO_{y}(OH)_{z}, NiO_{y}(OH)_{z}, AlO_{y}(OH)_{z}, MgO_{y}(OH)_{z}, and ZnO_{y}(OH)_{z} shown in FIG. 6A through FIG. 6D, FIG. 5A through FIG. 5D, and FIG. 7A through FIG. 7D. Weak wettability and high formation enthalpy result in the formation of ultrafine particles, for example, MnO_{y}(OH)_{z} NPs with a size of ˜5 nm (FIG. 5A, FIG. 6A); and CuO_{y}(OH)_{z}, RuO_{y}(OH)_{z}, RhO_{y}(OH)_{z}, PdO_{y}(OH)_{z}, PtO_{y}(OH)_{z}, AuO_{y}(OH)_{z} NPs with sizes of 1˜2 nm (FIG. 5A through FIGS. 5J, FIG. 6E through FIG. 6J). The metal ions loaded on the SiOₓ NSs can further react with other chemicals to transform them into different chemical forms. For example, dropwise adding H₂O₂ solution to the dispersion of Mn(II)Oy(OH)_{z} NPs on SiOₓ NSs changes the light yellowish color to a dark brown color, indicating the oxidation of Mn(II) to Mn(IV). This chemical transformation does not significantly change the dispersity and size of the MO_{y}(OH)_{z} NPs on the SiOₓ NS's surface (FIG. 7D and FIG. 7H).

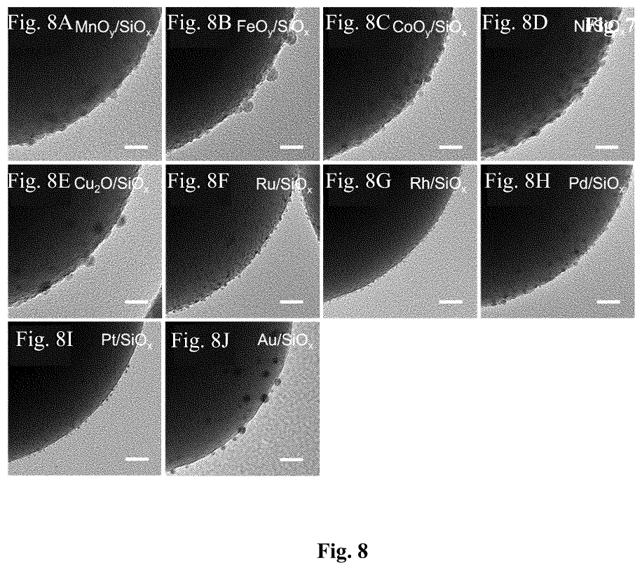

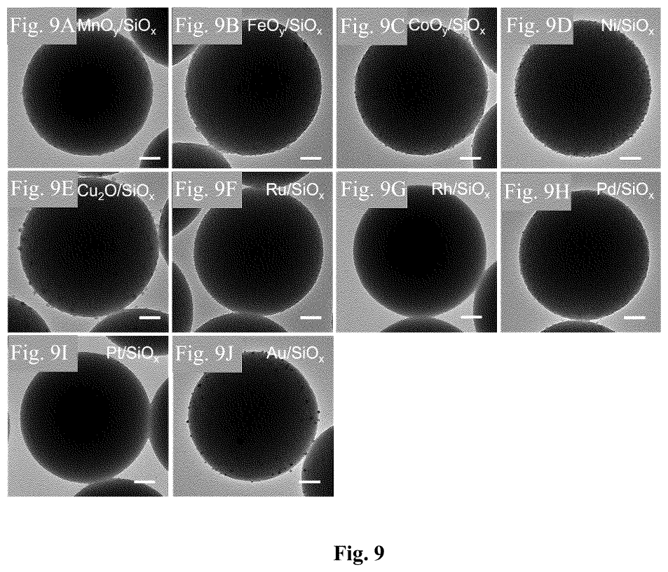

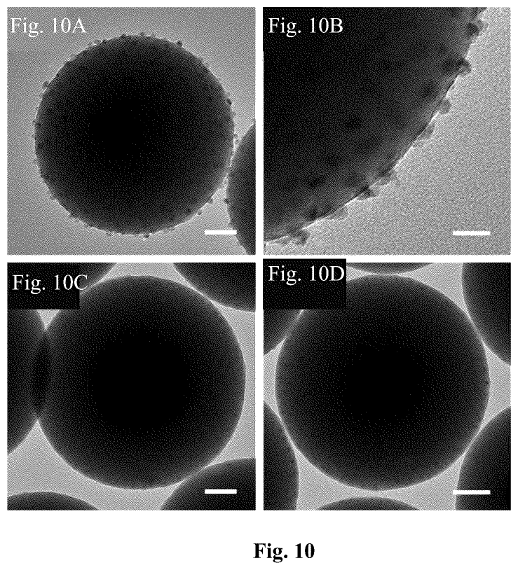

The loaded MO_{y}(OH)_{z} can also react with H₂ to be reduced at elevated temperatures, i.e., 250 or 550° C., producing ufMNPs. The latter group of MO_{y}(OH)_{z} are deposited as individual NPs, even with spatial distribution on the SiOₓ NSs, and small in size, ensuring that the following reduction of MO_{y}(OH)_{z} NPs transforms them into uniformly distributed ufMNPs. Reducing the thin layers of MO_{y}(OH)_{z} of the former group with appropriate reaction kinetics removes 0 and OH to shatter the film into evenly dispersed ufMNPs on the SiOₓ NSs. Depending on the chemical property of a metal element, its corresponding MO_{y}(OH)_{z} may not be reduced or completely reduced at a mild temperature. The composite particles of SiOₓ NSs with ufMNPs is denoted as ufMNPs/SiOₓ in the following contents. Typical TEM images of the ufMNPs/SiOₓ composite particles are shown in FIG. 8 and FIG. 9, confirming the uniform distribution and small sizes (<5 nm) of the ufMNPs. The reduction temperature (or operation temperature in applications) influences the size of the ufMNPs because of the sintering effect at higher temperatures. For example, the Ni ufMNPs produced from reduction at 550° C. exhibit sizes of 4.3±0.6 nm (FIG. 8D), and annealing them in the forming gas at 750° C. increases their sizes to 17.5±2.7 nm (FIG. 10A and FIG. 10B). The sintering can be alleviated by coating the metal surfaces with a skinny layer of silica to prevent (or slow) the diffusion of metal atoms at high temperatures. When the as-synthesized Ni ufMNPs/SiOₓ composite particles present in FIG. 8D are coated with a 5-nm silica layer (FIG. 10C), the size of the Ni ufMNPs remains unchanged upon thermal annealing at 750° C. (FIG. 10D).

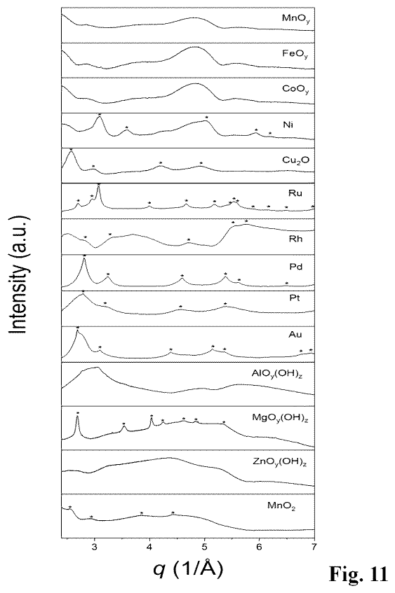

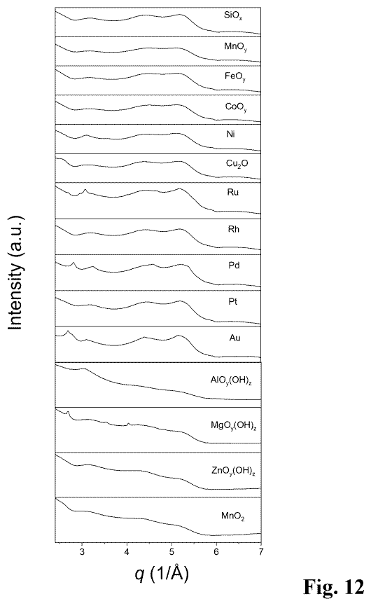

Because of the small sizes of the ultrafine NPs formed from the thermal reduction of MO_{y}(OH)_{z} on SiOₓ NSs, the mass percentages of the ultrafine NPs in the composite particles are low (i.e., 1 to 2 wt. %). A synchrotron x-ray beam with a high flux has been used to examine these composite particles in order to record signals from the low-loading ultrafine NPs with decent signal-to-noise ratios. Wide-angle x-ray scattering (WAXS) patterns are collected to analyze the crystalline structures and compositions of the ultrafine NPs. FIG. 11 plots the WAXS patterns of the ultrafine NPs derived from the reduction of MO_{y}(OH)_{z} containing different metal cations. These WAXS patterns are generated by subtracting the WAXS signal of the SiOₓ NSs from the WAXS patterns of the composite particles (FIG. 12). The WAXS pattern of the SiOₓ NSs in FIG. 12 exhibits several broad peaks in the range of q=2.4 to 7. The appearance of these broad peaks depends on the synthesis method and the post-treatment process (S. Lee, H. Xu, H. Xu, Am. Mineral. 2022, 107, 1353). For example, the x-ray diffraction (XRD) pattern of an opal has weak and broad peaks around d values of 1.21, 1.45, 2.00, 2.44 Å, corresponding to q values of 5.19, 4.33, 3.14, 2.58 Å⁻¹ with the x-ray beam energy of 13.3 keV. In accordance with the reported data, these peaks are also found in the WAXS pattern of the SiOₓ NSs, located at q=3.17, 4.42, and 5.18 Å⁻¹. The peaks at 5.18 and 4.42 Å⁻¹ originate from the pseudo-hexagonal symmetry of the short-range SiO₂ structure, and the one at 3.17 Å⁻¹ is associated with the (004) reflection of orthorhombic tridymite and the (222) reflection of p-cristobalite. It is reported that treating the amorphous SiOₓ with solutions of different pH values could change these peaks' relative intensities. It should be noted that during the metal loading process, the SiOₓ NSs would be further influenced by aqueous solutions of various pH values followed by thermal reduction at different temperatures. Therefore, the relative intensities of the peaks originating from the SiOₓ NS support could possibly vary among different samples.

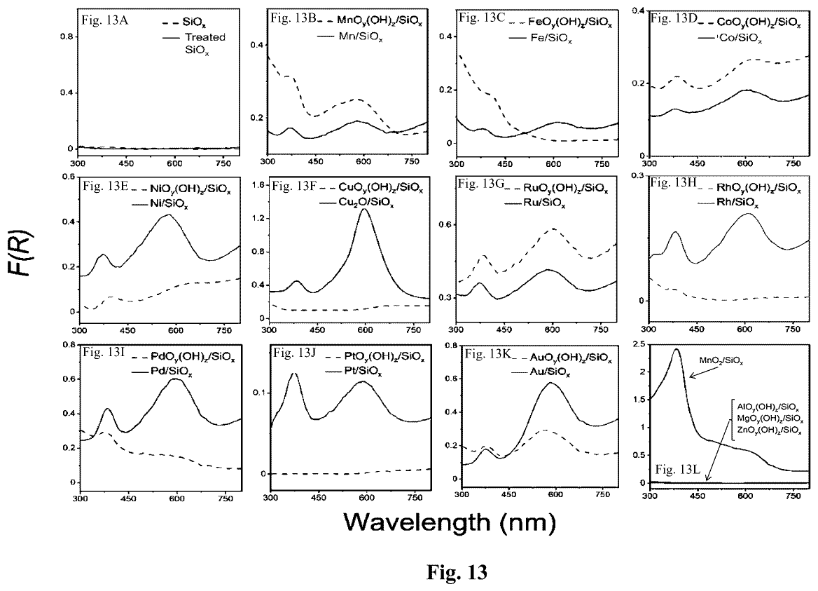

The WAXS pattern of SiOₓ NSs in the measured range exhibits three broad peaks corresponding to their amorphous phase. The strong SiOₓ signals may not be completely subtracted, particularly for the ultrafine NPs with amorphous phases showing weak WAXS. For example, the ultrafine NPs containing Mn, Fe, and Co do not present any sharp (or narrow) WAXS peaks but only broad peaks similar to SiOₓ NSs, indicating that the ultrafine NPs are in the format of amorphous phase and made of oxides. Even though the reduction temperatures applied are perceived to be able to reduce the metal to the metallic state, the presence of oxides rather than metals in these ultrafine NPs could be ascribed to the diffusion of oxygen atoms into the lattice of metal nanoparticles during transportation of the samples to the beamline, resulting in the loss of long-range ordering of metal atoms. Therefore, these three samples are labeled as MO_{y}/SiOₓ composite particles in FIG. 4 to match the corresponding WAXS patterns, avoiding the possible confusion. In fact, the thermal reduction of MO_{y}(OH)_{z}, containing Mn, Fe, or Co in the forming gas does result in the formation of the corresponding metallic ufMNPs, which can be reflected in the spectroscopic study shown in FIG. 13. The WAXS patterns of the ultrafine NPs containing Ni, Ru, Rh, Pd, Pt, and Au exhibit well-defined peaks corresponding to the face-centered cubic (fcc) lattices with different lattice constants, which are consistent with crystalline metals (Table S2), indicating that MO_{y}(OH)_{z} deposited on the SiOₓ NSs are completely reduced to ufMNPs.

TABLE 2
Summary of the crystalline plane reflection peak positions
of the ultrafine nanoparticles in their WAXS patterns.

| | | | |
|---|---|---|---|
| q (Å⁻¹) | Crystal plane | q (Å⁻¹) | Crystal plane |

| | |
|---|---|
| Ni | Cu₂O |

| | | | |
|---|---|---|---|
| 3.08 | (111) | 2.58 | (111) |
| 3.59 | (200) | 2.98 | (200) |
| 5.03 | (220) | 4.20 | (220) |
| 5.92 | (311) | 4.93 | (311) |
| 6.16 | (222) | | |

Ru

| | | | |
|---|---|---|---|
| 2.69 | (100) | 5.60 | (201) |
| 2.95 | (002) | 5.88 | (004) |
| 3.07 | (101) | 6.14 | (202) |
| 4.00 | (102) | 6.48 | (104) |
| 4.66 | (110) | 6.99 | (203) |
| 5.18 | (103) | | |
| 5.38 | (200) | | |
| 5.51 | (112) | | |

| | |
|---|---|
| Rh | Pd |

| | | | |
|---|---|---|---|
| 2.84 | (111) | 2.81 | (111) |
| 3.31 | (200) | 3.24 | (200) |
| 4.69 | (220) | 4.59 | (220) |
| 5.49 | (311) | 5.39 | (311) |
| 5.74 | (222) | 5.61 | (222) |
| | | 6.48 | (400) |

Pt Au

| | | | |
|---|---|---|---|
| 2.78 | (111) | 2.68 | (111) |
| 3.20 | (200) | 3.10 | (200) |
| 4.57 | (220) | 4.38 | (220) |
| 5.35 | (311) | 5.15 | (311) |
| | | 5.38 | (222) |
| | | 6.76 | (331) |
| | | 6.90 | (420) |

| | |
|---|---|
| MgO_{y}(OH)_{z} | MnO₂ |

| | | | |
|---|---|---|---|
| 2.33 | (100) | 2.57 | (100) |
| 2.68 | (101) | 2.93 | (101) |
| 3.53 | (102) | 3.84 | (102) |
| 4.03 | (110) | 4.45 | (110) |
| 4.24 | (111) | | |
| 4.61 | (103) | | |
| 4.83 | (201) | | |
| 5.34 | (202) | | |

The ultrafine NPs derived from the MO_{y}(OH)_{z} containing Cu exhibit a WAXS pattern showing a set of fcc peaks, but the lattice constant matches that of Cu₂O rather than Cu. The result indicates that the temperature of 250° C. is not high enough to reduce Cu(II) in the MO_{y}(OH)_{z} NPs to zero-valence Cu. The Cu₂O ultrafine NPs (FIG. 8E) are stable in the ambient environment. The MO_{y}(OH)_{z}/SiOₓ composite particles containing Al(III), Mg(II), and Zn(II) are not thermally treated in 5% H₂/N₂ gas because their reduction temperatures are beyond the limit of our furnace. In principle, these MO_{y}(OH)_{z} could be reduced to ufMNPs at high enough temperatures. The AlO_{y}(OH)_{z} and ZnO_{y}(OH)_{z} films on the SiOₓ NSs (FIG. 7A and FIG. 7C) exhibit broad WAXS peaks, indicating their amorphous nature. In contrast, the MO_{y}(OH)_{z} film containing Mg(II) (FIG. 7B) shows well-defined narrow WAXS peaks corresponding to those of Mg(OH)₂. The MO_{y}(OH)_{z} NPs containing Mn(II) (FIG. 5A) react with H₂O₂, leading to the formation e-MnO₂ NPs that are identified by fitting the series of WAXS peaks (MnO₂ curve, FIG. 11). The different reduction potentials of different metal cations require different temperatures to reduce the corresponding MO_{y}(OH)_{z} into zero-valence metals in the forming gas. The metal cations with a lower reduction potential need a higher temperature to be transformed into the metal. Although not all MO_{y}(OH)_{z} deposited on SiOₓ NSs presented in FIG. 5 and FIG. 7 could be reduced to their corresponding ufMNPs in our available furnace, the successful production of ufMNPs of some metals (e.g., Ni, Ru, Rh, Pd, Pt, and Au) sheds a light on the feasibility of loading ufMNPs on SiOₓ NSs through the controlled loading of MO_{y}(OH)_{z} and the following thermal reduction in the forming gas.

Diffuse reflectance spectroscopy (DRS) of the composite particles of SiOₓ NSs loaded with MO_{y}(OH)_{z} and derived ufMNPs is studied in the ultraviolet-visible (UV-vis) spectral range using a spectrometer equipped with an integrating sphere. The DRS spectrum of a sample can accurately represent its optical absorption property by eliminating the interferences of light scattering. For example, the as-synthesized SiOₓ NSs and those with rich —Si—O⁻ surface groups show the DRS spectra with essential no signal in the examined spectral range (300-800 nm) (FIG. 13A), indicating that the SiOₓ NSs exhibit negligible optical absorption even though they have strong optical scattering. Because of the highest geometrical symmetry of the SiOₓ NSs, optical scattering of the SiOₓ NSs with a diameter of 346.8 nm can generate strong scattering resonances around 380 nm and 600 nm, producing significantly enhanced electric fields near the SiOₓ NS's surface. The locally enhanced electric fields increase the optical absorption in the ultrafine NPs on the SiOₓ NSs to show two strong absorption peaks at the scattering resonance bands regardless of whether the absorption spectra of the freestanding ultrafine NPs exhibit peaks or not (FIG. 13B through FIG. 13L). If the ultrafine NPs or films loaded on the SiOₓ NSs do not absorb light at all in the studied spectral range, the optical scattering resonances of the SiOₓ NSs do not induce optical absorption in the supported materials, for example, MO_{y}(OH)_{z} containing Al, Mg, and Zn (FIG. 13L). The apparent optical absorption spectrum of a composite particle sample is the product of the intrinsic optical absorption spectrum of the supported NPs or films and the scattering spectrum of the SiOₓ NSs.

Although two peaks are always observed in the DRS spectrum for each sample with broadband absorption, the relative intensities of these two peaks (or the ratio of peak intensity for these two peaks) are not always similar for all samples because different supported NPs or films (i.e., light absorber) exhibit different intrinsic DRS spectra. For example, the composite particles containing the freshly deposited MnO_{y}(OH)_{z} NPs exhibit a more intense DRS peak at the short wavelength (FIG. 13B, dashed curve), which is ascribed to the partial oxidation of Mn(II) to Mn(III) in air. The presence of Mn(III) results in O²⁻→Mn³⁺ charge transfer that generates a strong optical absorption band around 367 nm in freestanding particles. The overlap of this charge transfer absorption band with the scattering resonance band of the SiOₓ NSs leads to observation of only one intense DRS peak around 380 nm. Once the freshly deposited MnO_{y}(OH)_{z} NPs are thermally reduced at 550° C. in the forming gas, the contribution of the O²⁻→Mn³⁺ charge transfer to optical absorption decreases, significantly lowering the corresponding DRS peak intensity. As a result, the DRS peak at the longer wavelength becomes more pronounced than that at the shorter wavelength in the reduced sample (FIG. 13B, solid curve). The DRS spectrum of the reduced sample containing Mn has a similar profile to those of the reduced samples containing other metal elements shown in FIG. 13C through FIG. 13K. The spectral similarity indicates that MnO_{y}(OH)_{z} is reduced to Mn ufMNPs as other ufMNPs. The retention of the metallic characteristics for the Mn ufMNPs benefits from the minimum time of exposing the as-synthesized sample to air during the DRS measurement. The DRS measurement can be done with the in-house spectrometer, avoiding long time transportation and exposure to air. Each spectrum can be collected within a short time (<2 minutes), further minimizing the possible oxidation. The ufMNPs of transition metals (except Au) usually exhibit peakless broadband optical absorption in the UV-vis range, which can be enhanced by the scattering resonances of SiOₓ NSs to exhibit two DRS peaks. The sample containing the freshly deposited FeO_{y}(OH)_{z} film shows only one DRS peak at the shorter wavelength, while two DRS peaks at both the shorter and longer wavelengths are observed after the sample is reduced at 550° C. (FIG. 13C), indicating that the reduction converts FeO_{y}(OH)_{z} film to Fe ufMNPs. The DRS spectra of the sample containing CoO_{y}(OH)_{z} and RuO_{y}(OH)_{z} do not change significantly in profile except for lowered intensity and slight redshift of both peaks after thermal reduction into ufMNPs (FIG. 13D and FIG. 13G), indicating that the intrinsic optical absorption of both the thin CoO_{y}(OH)_{z} film and ultrafine RuO_{y}(OH)_{z} NPs also exhibit broadband profile with possible peaks at long wavelengths originated from charge transfer between metal ions and oxygen anions or hydroxide anions.

The DRS spectra of SiOₓ NS-supported ufMNPs made of other metals (e.g., Ni, Rh, Pd, Pt, Au) exhibit much stronger signals than the corresponding MO_{y}(OH)_{z} NPs, particularly at the long wavelengths (FIG. 13E, FIG. 13H, FIG. 13I, FIG. 13J, and FIG. 13K), indicating that the charge transfer between metal ions and oxygen is weak. Since the localized surface plasmon resonance (LSPR) in Au ufMNPs exhibits an intrinsic optical absorption peak around 530 nm, the DRS peak of the Au-ufMNPs/SiOₓ composite sample at the longer wavelength is much stronger than the peak at the shorter wavelength (FIG. 13K). The MO_{y}(OH)_{Z} NPs are transformed to Cu₂O ultrafine NPs after thermal reduction at 250° C., which is not high enough to fully reduce Cu(II) to metallic Cu. The Cu₂O/SiOₓ composite particles also exhibit two DRS peaks similar to the composites containing ufMNPs, but the peak intensity at the longer wavelength is much stronger than the peak at the shorter wavelength (FIG. 13F). The intense peak at ˜600 nm is unrelated to the plasmonic property of Cu₂O NPs because the LSPR band of the Cu₂O NPs smaller than 10 nm is located at the wavelengths below 500 nm. On the other hand, the DRS peak position (i.e., ˜600 nm) is close to the bandgap of Cu₂O (i.e., ˜2.01 eV), indicating that the ultrafine Cu₂O NPs undergo a strong direct bandgap absorption upon exposure to light. In contrast, the DRS spectrum of the MnO₂/SiOₓ composite sample containing ultrafine MnO₂ NPs exhibits a much stronger peak at the shorter wavelength at −380 nm (FIG. 13L), which benefits from the intrinsic absorption peak at 355 nm of the freestanding MnO₂ NPs. The DRS spectra presented in FIG. 13 clearly show that the weak optical absorption of ufMNPs is significantly enhanced, particularly in the visible region showing a strong peak around 600 nm (i.e., the scattering resonance band of the SiOₓ NS) regardless of the type of element. Such enhancement in optical absorption also applies to ultrafine NPs and ultrathin films of other compositions, which have intrinsic optical absorption (Balan, L. et al., Green Chemistry 2013, 15, 2191-2199; Suksomboon, M. et al., ACS Omega 2021, 6, 20804-20811; Bavykin, D. V. et al., Journal of Catalysis 2005, 235, 10-17; Zuber, A. et al., Sensors and Actuators B: Chemical 2016, 227, 117-127; Pan, H. et al., ACS Sustainable Chemistry & Engineering 2018, 6, 1872-1880; Soldatova, A. V. et al., Environmental Science & Technology 2019, 53, 4185-4197).

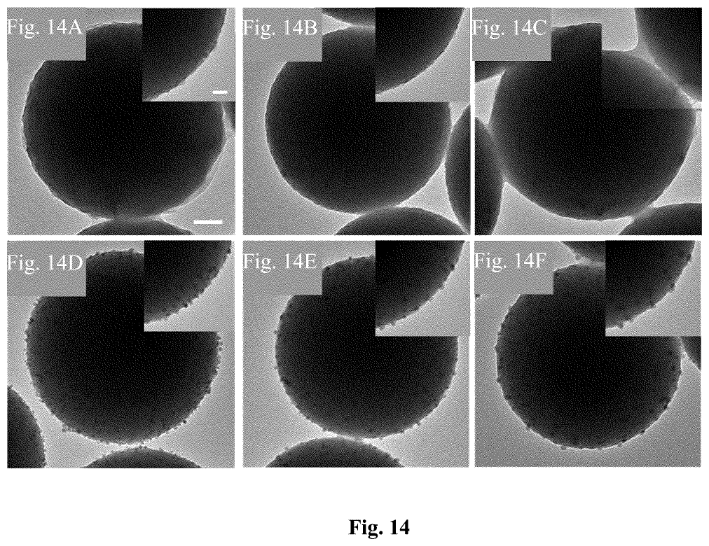

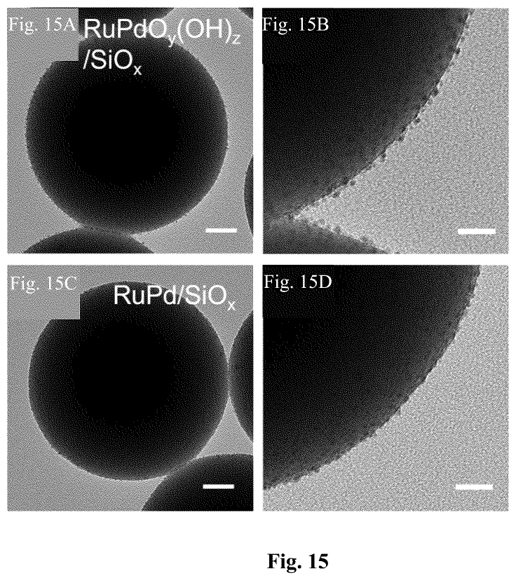

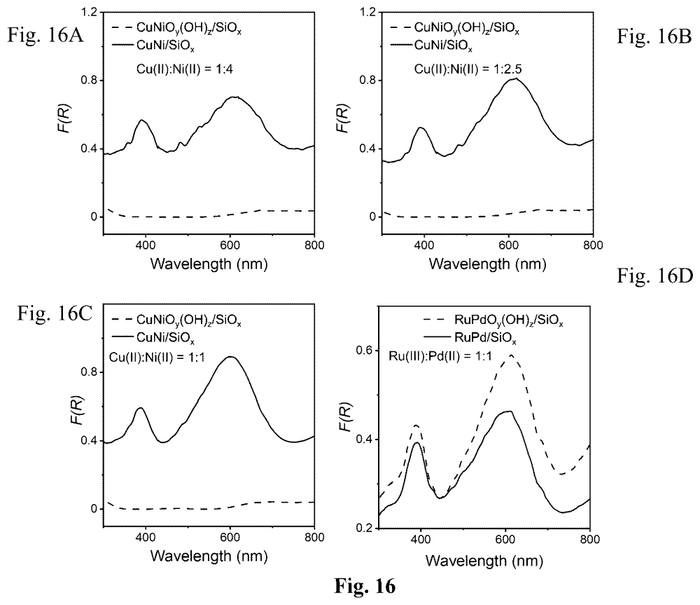

The success of the strategy of FIG. 2 in evenly loading metal ions onto the surface of SiOₓ NSs in a controlled manner can be extended to simultaneously loading multiple types of metal ions when the required deposition pH values are similar. Thermally reducing the deposited MO_{y}(OH)_{z} containing multiple types of metal ions could form alloyed ufMNPs on the SiOₓ NS's surface. For example, mixing the SiOₓ NSs with an aqueous solution of pH=10.15 containing both Cu(II) and Ni(II) precursor ions at molar ratios of 1:4 to 1:2.5 to 1:1 loads CuNiO_{y}(OH)_{z} thin films on the SiOₓ NSs (FIG. 14A through FIG. 14C). Reducing the composite particles in the forming gas at 550° C. transforms the CuNiO_{y}(OH)_{z} thin films to CuNi alloy ufMNPs with sizes of 2-5 nm (FIG. 14D through FIG. 14F). The bimetallic RuPd ufMNPs are also formed on the SiOₓ NSs by simultaneously depositing both Ru(III) and Pd(II) ions from a solution with pH=8.9, followed by thermal reduction at 250° C. (FIG. 15). Because of the scattering resonances in the SiOₓ NSs, the enhancement of optical absorption in the supported bimetallic ufMNPs is also observed with two strong DRS peaks around 380 nm and 600 nm (FIG. 16). It is worth pointing out that the ratio of the DRS peak intensity at the longer wavelength to that at the shorter wavelength for the composite particles containing CuNi ufMNPs is lower than the ratio for the composite particles containing Cu₂O NPs shown in FIG. 13F. This difference indicates that Cu(II) ions in the CuNiO_{y}(OH)_{z} thin films are fully reduced to metallic Cu at a higher temperature of 550° C. The DRS intensity increases with the increase of Cu content in the CuNi ufMNPs due to the plasmonic properties of metallic Cu (Pramanik, S. et al., Journal of Nanoparticle Research 2011, 13, 321-329).

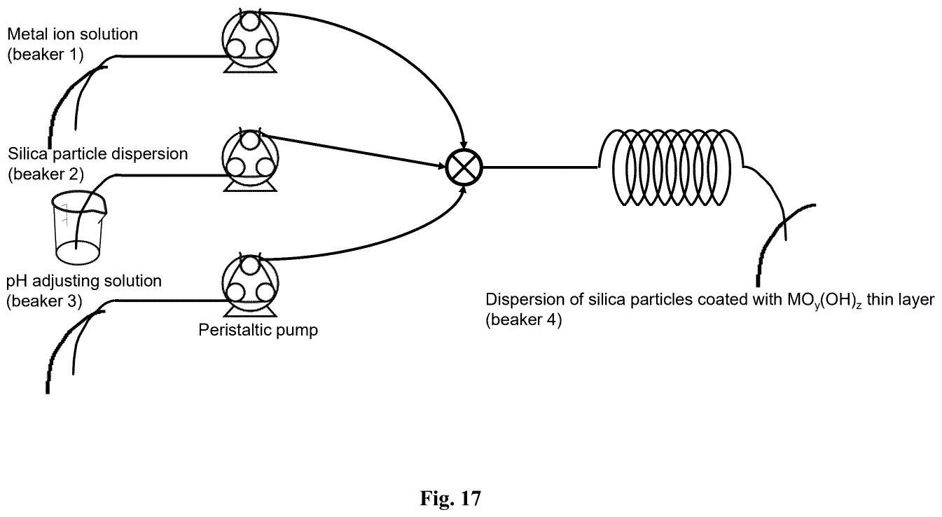

The strategy depicted in FIG. 2 has been demonstrated for successfully loading evenly dispersed MO_{y}(OH)_{z} thin coating on the SiOₓ NSs with rich —Si—O⁻ groups through promoted surface acid-base reaction between metal cations and hydroxide anions, which prevents the precipitation of freestanding metal hydroxides through homogeneous nucleation. The uniform spatial distribution of MO_{y}(OH)_{z} and controlled loading enables their transformation into ufMNPs through thermal reduction in the forming gas at an appropriate temperature. The resulting ufMNPs have sizes smaller than 5 nm to exhibit large surface-to-volume ratios, while the SiOₓ NSs support maintaining the uniform distribution and stability of the ufMNPs. The scattering resonances in the SiOₓ NSs locally generate strong electric fields near their surfaces to enhance the optical absorption in the ufMNPs dispersed on the SiOₓ surface. The large surface area and enhanced optical absorption of the ufMNPs on the SiOₓ NSs could be a class of promising photocatalysts relying on hot carrier chemistry. The generality of the strategy of FIG. 1 in synthesizing ufMNPs expands the composition space of the ufMNPs, proving a materials platform for studying versatile photocatalytic reactions (Sun, Y. and Tang, Z., MRS Bulletin 2020, 45, 20-25). FIG. 17 is a design for flow synthesis. Beaker 4 and beaker 2 can be switched to add additional layers of MO_{y}(OH)_{z}. Metal ions in beaker 1 can be switched from one element to the other, allowing coating multiple layers of MO_{y}(OH)_{z} of various compositions. The geometry of silica particles in beaker 2 could be any shape even with porosity. Silica particles in beaker 2 could be switched to any oxide particles including TiO₂, V₂O₅, MnO₂, Fe₂O₃, Co₂O₃, NiO, CuO, ZnO, CeO₂, WO₃, etc.

### Experimental Section

Synthesis of Silica Spheres: The synthesis relied on the controlled hydrolysis of tetraethyl orthosilicate (TEOS) and condensation of the hydrolyzates. In a typical synthesis, 24.60 mL of ammonium hydroxide solution (28-30 wt. % in water, Fischer Scientific) was added to a mixture of 45.45 mL of deionized (DI) H₂O and 120 mL of isopropanol (Fisher Scientific) at room temperature. Under magnetic stirring at a rate of 400 rpm, the solution was then heated to 40° C. by a heating jacket equipped with a J-type thermocouple. To this solution, 10.88 mL of TEOS (98%, Sigma-Aldrich) was then injected. The temperature of 40° C. and magnetic stirring were maintained throughout the synthesis for 6 h. The resulting SiOₓ NSs were collected by centrifugation and washed with ethanol. The collected SiOₓ NSs were dried overnight in an oven at 60° C. (Stöber, W. et al., Journal of Colloid and Interface Science 1968, 26, 62-69).

Enrichment of Surface —Si—O⁻ Group on SiOₓ NSs: One gram of the dried SiOₓ NSs was dispersed in 200 mL of DI H₂O with the assistance of ultrasonication in a 500 mL three-neck round-bottom flask. Monitored by a pH meter (Apera Instruments PH700), to the dispersion was dropwise added 28-30 wt. % aqueous ammonia hydroxide or 0.1 M nitric acid solution until the pH value reached 11.10. Under magnetic stirring at a rate of 400 rpm, the dispersion was heated up to 100° C. followed by refluxing for 24 h. After the dispersion was cooled down to room temperature, the resulting SiOₓ NSs were collected by centrifugation and washed once with ethanol. The collected SiOₓ NSs were dried at room temperature.

Deposition and Reduction of MO_{y}(OH)_{z} on SiOₓ NSs: Forty milligrams of the treated SiOₓ NSs were dispersed in 20 mL of DI H₂O with the assistance of ultrasonication. To this dispersion, 10 mM of aqueous ammonium hydroxide solution was added dropwise, followed by heating to the desired temperature. The optimized reaction conditions for each metal precursor are listed in Table S1. A 0.1-mL aqueous metal precursor solution containing 1 wt. % of metal was injected into the dispersion (2 wt. % for Au). The color change started in 15 s, indicating the deposition of metal ions on the SiOₓ NSs. After 1 h of continuous aging, the MO_{y}(OH)_{z}/SiOₓ composite particles were collected by centrifugation and washed with DI H₂O and ethanol. The sample was then dried at room temperature in the ambient environment. Thermal reduction of MO_{y}(OH)_{z} was carried out in a tube furnace. In a continuous flow of 5% H₂/N₂ gas (i.e., forming gas) at a rate of 30 mL/min the sample powder was heated to an appropriate temperature at a ramping rate of 10° C./min. The reaction was maintained at the set temperature for 2 h followed by cooling to room temperature while the forming gas continuously flowed in the tube.

Characterization: Scanning electron microscopy (SEM) images were obtained using a field-emission microscope (FEI Quanta FEG 450) operated with an acceleration voltage of 10 kV at a high vacuum mode. Transmission electron microscopy (TEM) images were taken using JEOL JEM-1400 microscope operated at 120 kV. Zeta-potential (ζ) of colloidal nanoparticles was measured with a zeta potential analyzer (Malvern Instruments Ltd., Zetasizer Nano-ZS). The synthesized ufMNP/SiOₓ composite particles were examined with synchrotron wide-angle x-ray scattering (WAXS), which was carried out at the beamline 12-ID-B of Advanced Photon Source (APS), Argonne National Laboratory (ANL). The wavelength of the x-ray was 0.9322 Å, corresponding to a photon energy of 13.3 keV. The composite powders were packed and sealed in Kapton® tubes, which were shipped to and measured at the beamline. The scattering signals were collected using an imaging plate detector with a resolution of 2048×2048 pixels. The sample-to-detector distance (180 mm) was calibrated by fitting the WAXS pattern of a standard CeO₂ sample. The recorded two-dimensional (2D) scattering patterns were reduced to one-dimensional (1D) curves using the Fit2D software, along with the background subtraction and intensity normalization. Ultraviolet-visible absorption spectra were analyzed with a UV-vis spectrophotometer (Thermo Scientific, Evolution 220), and DRS spectra were obtained with the same instrument equipped with an integrating sphere detector.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

We claim:

1. A method of fabricating a nanoparticle material, the method comprising:
providing silica nanospheres;
dispersing the silica nanospheres in a first solvent;
collecting and drying the silica nanospheres;
dispersing the silica nanospheres in a second solvent and adding a metal precursor to create composite nanoparticles;
collecting and drying the composite nanoparticles to create a nanoparticle material.

2. The method of claim 1, wherein the step of dispersing the silica nanospheres in a first solvent further comprises the step of altering the pH of the first solvent to reach a value between 8 and 13.

3. The method of claim 2, wherein the step of altering the pH of the first solvent comprises the step of adding a base or an acid to the first solvent.

4. The method of claim 1, wherein the step of dispersing the silica nanospheres in a second solvent further comprises the step of altering the pH of the second solvent to reach a value between 5 and 14.

5. The method of claim 4, wherein the step of altering the pH of the second solvent to reach a value between 5 and 14 comprises the step of adding an acid or a base to the second solvent.

6. The method of claim 1, wherein the metal precursor is selected from the group consisting of: manganese(II) nitrate hydrate (Mn(NO₃)₂·xH₂O), Iron(II) chloride (FeCl₂), cobalt(II) nitrate hexahydrate (Co(NO₃)₂·6H₂O), nickel(II) nitrate hexahydrate (Ni(NO₃)₂·6H₂O), copper(II) nitrate trihydrate (Cu(NO₃)₂·3H₂O), ruthenium(III) chloride hydrate (RuCl₃·xH₂O), sodium tetrachloropalladate(II) hydrate (Na₂PdCl₄·xH₂O), sodium hexachlororhodate(III) hydrate (Na₃RhCl₆·xH₂O), tetrachloroauric(III) acid trihydrate (HAuCl₄·3H₂O), sodium tetrachloroplatinate(II) hydrate (Na₂PtCl₄·xH₂O), potassium tetrachloroplatinate(II) hydrate (K₂PtCl₄·xH₂O), sodium hexachloroplatinate (Na₄PtCl₆), potassium hexachloroplatinate (K₄PtCl₆), magnesium chloride (MgCl₂), aluminum nitrate nonahydrate (Al(NO₃)₂·9H₂O), zinc nitrate hexahydrate (Zn(NO₃)₂·6H₂O), and combinations thereof.

7. The method of claim 1, wherein the step of adding a metal precursor comprises the step of adding an aqueous metal precursor solution with less than 50.0 wt % of a metal precursor.

8. The method of claim 1, wherein the composite nanoparticles comprise metal nanoparticles with diameters less than 40 nm.

9. The method of claim 1, wherein the step of collecting and drying the composite nanoparticles further comprises the step of reducing the composite nanoparticles.

10. The method of claim 9, wherein the step of reducing the composite nanoparticles comprises the step of thermally reducing the composite nanoparticles.

11. The method of claim 10, wherein the step of thermally reducing the composite nanoparticles comprises the step of contacting the composite nanoparticles with a flow of 5% H₂/N₂ gas.

12. The method of claim 9, wherein the step of reducing the composite nanoparticles further comprises the step of coating the composite nanoparticles with a dielectric material coating.

13. The method of claim 1, wherein the silica nanospheres have diameters less than 1500 nm.

14. The method of claim 1, wherein the step dispersing the silica nanospheres in a second solvent, altering the pH of the second solvent, and adding a metal precursor the composite nanoparticles, comprises the step of anchoring the metal precursors to the surface of the silica nanospheres through metal-silane bonds.

15. A nanoparticle material comprising silica nanospheres, wherein the silica nanospheres are coated with metal nanoparticles with diameters less than 40 nm.

16. The nanoparticle material of claim 15, wherein the silica nanospheres comprise a dielectric material.

17. The nanoparticle material of claim 15, wherein the dielectric material comprises a compound selected from the group consisting of silicon oxide (SiO₂), aluminum oxide (Al₂O₃), tantalum pentoxide (Ta₂O₅), titanium oxide (TiO₂), tungsten Oxide (WO₃), zirconium oxide (ZrO₂), yttrium oxide (Y₂O₃), silicon nitride (SiN₄), cerium oxide (CeO₂), iron oxide (Fe₂O₃), lanthanum oxide (La₂O₃), hafnium oxide (HfO₂), chromium oxide (Cr₂O₃), strontium titanate (STO), barium strontium titanate (BST), PLZT (lead zirconate titanate), lead magnesium niobate (PMN), and lead zirconate titanate (PZT), and combinations thereof.

18. The nanoparticle material of claim 15, wherein the silica nanospheres have diameters less than 1500 nm.

19. The nanoparticle material of claim 15, wherein the metal nanoparticles comprises a metal selected from the group consisting of: gold (Au), silver (Ag), copper (Cu), aluminum (Al), magnesium (Mg), iron (Fe), cobalt (Co), nickel (Ni), ruthenium (Ru), palladium (Pd), rhodium (Rh), platinum (Pt), manganese (Mn), zinc (Zn), molybdenum (Mo), tin (Sn), antimony (Sb), tungsten (W), rhenium (Re), iridium (Ir), and their combinations thereof.

20. The nanoparticle material of claim 15, wherein the metal nanoparticles are anchored to the surface of the nanospheres through metal-silane bonds.
